(19) United States
(12) Patent Application Publication
(10) Pub. No.: US 2026/0276899 A1
(43) Pub. Date: Sep. 17, 2026

(54) FIXTURE AND ASSOCIATED METHODS FOR HERMETIC FEEDTRHOUGH ASSEMBLY

(71) Applicant: CORNING RESEARCH & DEVELOPMENT CORPORATION, Corning, NY (US)

(72) Inventors: Tim Grygiel, Schoenebeck (DE); Wen-Lung Kuang, Taoyuan City (TW); Wei-Cheng Lee, Hsinchu County (TW); Yuan-He Teng, Hsinchu County (TW); Bartosz Adam Tylak, Poznan (PL)

(21) Appl. No.: 19/664,439

(22) Filed: Apr. 30, 2026

Related U.S. Application Data
(63) Continuation of application No. PCT/US2024/053816, filed on Oct. 31, 2024.
(60) Provisional application No. 63/547,018, filed on Nov. 2, 2023.

(51) Int. Cl. G02B 6/36; G02B 6/42; G02B 6/44

(52) U.S. Cl. CPC G02B 6/362; G02B 6/3636; G02B 6/3644; G02B 6/4248; G02B 6/4255; G02B 6/4266; G02B 6/443; G02B 6/44775

(57) ABSTRACT

A system for formation of a fiber assembly is provided. The system comprises a fixture comprising a first portion and a second portion. The system also includes a fiber and a first tube defining a first cavity therein. The first tube is configured to receive the fiber in the first cavity. The first portion is configured to be fixed relative to the fiber, the second portion is configured to be fixed relative to the first tube, and the second portion is configured to move relative to the first portion to move the first tube relative to the fiber. The system may also include a vacuum fixture configured to supply vacuum suction to assist in maintaining positioning of the first tube, the fiber, and the fixture relative to each other, and the fixture and the vacuum fixture may be removably attachable to each other.

### CROSS-REFERENCE TO RELATED APPLICATIONS

This application is a continuation of International Patent Application PCT/US2024/053816, filed Oct. 31, 2024, which claims priority to U.S. Provisional Patent Application No. 63/547,018, filed Nov. 2, 2023, entitled “Fixture and Associated Methods for Hermetic Feedthrough Assembly.” The aforementioned applications are hereby incorporated by reference in their entirety.

### FIELD

Embodiments relate generally to systems, assemblies, fixtures and methods for forming fiber assemblies.

### BACKGROUND

Various systems for the formation of hermetic feedthrough assemblies are not capable of generating fiber assemblies of different sizes. Instead, the dimensions of these systems are fixed and cannot be modified, preventing the dimensions of the final fiber assembly from being customized. In some systems, different sized fiber assemblies may be accomplished, but only after certain components of the system have been replaced with different components. Additionally, existing systems often do not allow epoxies to be injected or cured.

In existing systems for formation of fiber assemblies, Kovar® tubes in fiber assemblies lose a large amount of heat during glass soldering of the fiber assemblies. This occurs due to the fixtures within systems having a large contact area with the Kovar® tubes, leading to a high amount of heat loss through thermal conduction from the Kovar® tubes to the fixtures. Additionally, in existing systems for formation of glass fiber systems, the angle of glass blocks relative to other portions of fibers in fiber assemblies is often not accurate because these glass soldering fixtures do not have any sort of mechanism to effectively maintain these angles.

Additionally, some glass soldering fixtures have various shortcomings. These glass soldering fixtures often require parts of the fixture to be changed out in order to accommodate different fiber lengths. Glass soldering fixtures often are unable to be used for epoxy injection and epoxy curing, and fiber assemblies often must be moved to other fixtures in order to complete epoxy injection and epoxy curing.

### BRIEF SUMMARY

Embodiments relate generally to systems, assemblies, fixtures and methods for forming fiber assemblies such as hermetic feedthrough assemblies. Various embodiments may enable fiber assemblies to be created with high precision, reliability, accuracy, and centricity. In some embodiments, vacuum suction may be used to maintaining position and/or orientations of various components relative to each other (such as by holding the fibers in a desired position/orientation). In some embodiments, fiber assemblies may be formed in an automated or semi-automated manner. Fiber assemblies may be made having different specifications, and various systems, assemblies, and fixtures may be easily adjusted in some embodiments to allow the size, shape, and dimensions of the fiber assemblies to be customized as desired.

Fiber assemblies may be created with primary tubes, and these primary tubes may be provided in the form of Kovar® tubes. During glass soldering, the primary tubes may be positioned in fixtures such that the primary tubes have a reduced contact area with the fixture. This may be accomplished by positioning the primary tubes at grooves (e.g., V-grooves) within the fixture. The reduced contact area between the primary tubes and the fixture may lead to a reduced amount of heat loss at the primary tubes through conduction.

Systems, assemblies, and fixtures may also include sufficient space for temperature sensors (e.g., thermocouples) to be positioned proximate to primary tubes and/or the fiber assemblies to monitor the temperature. Additionally, epoxies may be injected and cured through ultraviolet curing and/or thermal curing without requiring removal of components from fixtures. For example, components such as glass blocks, primary tubes, secondary tubes, and other positioning brackets may be retained on a fixture during ultraviolet curing and/or thermal curing.

Various fixtures described herein may ensure that components of assembled fiber assemblies are positioned appropriately to obtain the correct concentricity and position for all components. Primary tubes may comprise metal material, and the primary tubes may be heated using an induction heating coil. To prevent fibers from twisting from end-to-end, vacuum suction forces may optionally be utilized to position the fibers, and the vacuum suction forces may optionally be applied to ensure appropriate positioning of other components as well. Further adjustment in the positioning may optionally be made before the components are retained in their positions using brackets and screws. The middle component of fixture may use screw drives to move two screws to control the final precise positions of Kovar® tube according to different product requirements. After glass soldering is performed, epoxy may be injected and then cured. The positions of the various components in the system may be maintained appropriately through glass soldering, through epoxy curing, and through other processes.

Fiber assemblies that are formed using the systems described herein may be effective even in harsh conditions and after repeated use. Fiber assemblies that are formed may maintain effective hermetic seals. The fiber assemblies may be capable of passing a large number of liquid thermal shock cycles and a large number of temperature cycles. Fiber assemblies that are formed may operate effectively in damp and warm conditions (e.g., above around 85 degrees Celsius and around 85 percent humidity) for extended periods of time. Systems may be configured to generate fiber assemblies that are capable of experiencing a large amount of twisting, side forces in directions perpendicular to a longitudinal axis of the fiber assemblies, and linear forces that generally act parallel to a longitudinal axis of fiber assemblies without failure.

Even after laser stripping is performed on fibers, fibers may possess a tensile strength of about 2 kgf or more in some embodiments, and stripped fibers may also be cleaned before use. In some embodiments, the tension in fibers during assembly of fiber assemblies may be about 0.5 Newtons, and this tension level may be obtained through the use of torque wrenches and other components. Systems may also be configured to generate multiple fiber assemblies simultaneously—for example, two, three, four, five, or more fiber assemblies may be made at the same time using only one fixture.

Systems may maintain fiber tension with more precision and accuracy by using end screws. Fibers may be attached to a movable section of a fixture using a bracket, and the end screw may be used to adjust the position of the movable section and the attached bracket. This end screw may enable the tension in fibers to be maintained at consistent levels that are highly accurate and precise, and maintaining the tension may also allow straightness and centricity of fibers to be effectively maintained.

Also, primary tubes may be provided with a similar coefficient of thermal expansion at the front of the primary tubes and at the back of the primary tubes, thereby allowing the hermeticity stable under high temperature variation. For example, hermeticity may be retained at a level of less than about 10⁻⁹ Pa·m³/s even under difficult test conditions. Hermiticity may be improved by maintaining high concentricity for fibers at the front and back sides of primary tubes.

Optical performance of fiber assemblies may be highly related to the strength of fibers, the curing temperature, and the curing time. By controlling these parameters, breaks and cracks in fibers may be prevented when subjected to harsh conditions. Furthermore, fibers may be heated or soldered at consistent temperatures and lengths of time, and temperature sensors may maintain data that allows the temperature profile for fibers, primary tubes, and other components to be effectively monitored. By curing epoxy well in parallel, the mechanical properties of any fiber assemblies that are created may be improved.

In an example embodiment, a system for formation of a fiber assembly is provided. The system comprises a fixture comprising a first portion and a second portion. The system also comprises a fiber and a first tube defining a first cavity therein, the first tube configured to receive the fiber in the first cavity. The first portion is configured to be fixed relative to the fiber, the second portion is configured to be fixed relative to the first tube, and the second portion is configured to move relative to the first portion to move the first tube relative to the fiber.

In some embodiments, the system may also comprise a vacuum fixture configured to supply vacuum suction to assist in maintaining positioning of the first tube, the fiber, and the fixture relative to each other. Additionally, in some embodiments, the fixture and the vacuum fixture may be removably attachable to each other.

In some embodiments, the first tube may be a Kovar® tube. Furthermore, in some embodiments, the second portion may comprise a groove, and the second portion may be configured to receive the first tube at the groove. In some embodiments, the groove may be a V-groove.

In some embodiments, the system may also comprise epoxy, and the epoxy may be positioned at the first tube.

In some embodiments, the system may also comprise a second tube defining a second cavity therein, the second tube may be configured to receive the fiber in the second cavity. Furthermore, in some embodiments, the system may also comprise epoxy, and the epoxy may be configured to assist in positioning the first tube relative to the second tube.

In some embodiments, the system may also comprise a first bracket configured to be attached to the first portion of the fixture to assist in fixing the fiber relative to the first portion of the fixture. Additionally, in some embodiments, the system may also comprise a second bracket configured to be attached to the second portion of the fixture to assist in fixing the first tube relative to the second portion of the fixture. Furthermore, in some embodiments, the system may also comprise a pin positioned adjacent to the first tube, the second bracket may be configured to receive the pin, and the pin may be configured to be urged against the first tube.

In some embodiments, the system may also comprise at least one positioning screw configured to be adjustable to change a position of the first portion relative to the second portion. In some embodiments, the fixture, the first tube, and the fiber may each be configured to be thermally cured. Furthermore, in some embodiments, the fixture, the fiber, and the first tube may each be configured to be heated by an induction heating coil. In some embodiments, the fixture, the first tube, and the fiber may each be configured to undergo ultraviolet curing.

In another example embodiment, an assembly for formation of a fiber assembly is provided. The assembly comprises a fixture comprising a first portion and a second portion. The assembly also comprises a vacuum fixture configured to supply one or more suction forces. The first portion of the fixture is configured to be fixed relative to a fiber, and the second portion of the fixture is configured to be fixed relative to a first tube. The first tube defines a first cavity that is configured to receive the fiber therein. The second portion of the fixture is configured to move relative to the first portion of the fixture to move the first tube relative to the fiber. Additionally, the vacuum fixture is configured to assist in maintaining the positioning of the first tube, the fiber, and the fixture relative to each other by supplying vacuum suction.

In another example embodiment, a fixture for formation of a fiber assembly is provided. The fixture comprises a first portion and a second portion. The first portion is configured to be fixed relative to a fiber, and the second portion is configured to be fixed relative to a first tube. The first tube defines a first cavity configured to receive the fiber therein. The second portion is configured to move relative to the first portion to move the first tube relative to the fiber. In some embodiments, the second portion may comprise a V-groove and the second portion may be configured to receive the first tube at the V-groove.

In another example embodiment, a method for using a fixture for forming of a fiber assembly is provided. The method comprises providing a first tube defining a first cavity therein, with the first tube being configured to receive a fiber in the first cavity. The method also comprises positioning the first tube so that a fiber is received in the first cavity. The method also comprises providing a fixture comprising a first portion and a second portion, with the second portion being configured to move relative to the first portion. The method also comprises fixing the fiber relative to the first portion of the fixture and fixing the first tube relative to the second portion of the fixture.

In some embodiments, the method also comprises moving the first portion of the fixture relative to the second portion of the fixture to move the first tube relative to the fiber. Additionally, in some embodiments, fixing the fiber relative to the first portion of the fixture may be accomplished using a first bracket.

In some embodiments, the method may also comprise providing a second tube defining a second cavity therein, with the second tube being configured to receive the fiber in the second cavity. The method may also comprise positioning the second tube so that the fiber is received in the second cavity and attaching the first tube to the second tube using epoxy.

In another example embodiment, a fiber assembly is provided that is formed by a process. The process comprises providing a first tube defining a first cavity therein, with the first tube being configured to receive a fiber in the first cavity. The process also comprises positioning the first tube so that a fiber is received in the first cavity. The process also comprises providing a fixture comprising a first portion and a second portion, with the second portion being configured to move relative to the first portion. The process also comprises fixing the fiber relative to the first portion of the fixture and fixing the first tube relative to the second portion of the fixture.

In another example embodiment, a system for formation of a fiber assembly is provided. The system comprises a fixture comprising a movable section configured to move relative to other portions of the fixture. The system also comprises a fiber, a first bracket, and a second bracket. The first bracket is configured to be attached to the fixture at a location away from the movable section so that the fiber is restrained between the first bracket and the fixture. The second bracket is configured to be attached to the movable section so that the fiber is restrained between the second bracket and the movable section. The movable section and the second bracket are configured to be adjusted in position relative to other portions of the fixture to adjust a tension level within the fiber.

In some embodiments, the system also may also comprise an end screw, and the end screw may be configured to be rotated to adjust a position of the movable section and the second bracket. Furthermore, in some embodiments, the system may also comprise a torque wrench, and the end screw may be configured to be rotated using the torque wrench.

In some embodiments, the system may also comprise a first tube defining a first cavity therein, and the first tube may be configured to receive the fiber in the first cavity. Additionally, in some embodiments, the system may also include a temperature sensor, and the temperature sensor may be positioned proximate to a first end of the first tube.

In some embodiments, the fixture may comprise ceramic material. The movable section may comprise ceramic material in some embodiments. Also, in some embodiments, grooves may be defined in a portion of the fixture comprising ceramic material.

In some embodiments, a guide rail may extend through the movable section, and the guide rail may guide movement of the movable section along a particular path.

In some embodiments, the system may also comprise a secondary tube and epoxy. Furthermore, in some embodiments, the primary tube may define a window therein, the epoxy may be dispensed into the primary tube through the window, and the secondary tube may be received within the primary tube with the epoxy being used to bond the primary tube and the secondary tube together. Also, in some embodiments, epoxy may be dispensed when the primary tube is in a generally vertical orientation where the window is positioned at an upper end of the primary tube, and the epoxy may be dispensed into the primary tube at a position below the window by inserting a dispenser through the window. In some embodiments, the epoxy may be cured through ultraviolet curing or thermal curing.

In some embodiments, the fiber may be heated to a temperature of at least about 350 degrees Celsius. In some embodiments, a glass block may be provided at an end of the fiber.

In another example embodiment, an assembly for formation of a fiber assembly is provided. The system comprises a fixture comprising a movable section configured to move relative to other portions of the fixture. The system also comprises a first bracket and a second bracket. The first bracket is configured to be attached to the fixture at a location away from the movable section so that the fiber is restrained between the first bracket and the fixture. The second bracket is configured to be attached to the movable section so that the fiber is restrained between the second bracket and the movable section. The movable section and the second bracket are configured to be adjusted in position relative to other portions of the fixture to adjust a tension level within the fiber.

In some embodiments, the assembly may also comprise an end screw configured to be rotated to adjust a position of the movable section and the second bracket. Furthermore, in some embodiments, the end screw may be configured to be rotated using a torque wrench.

In some embodiments, the fixture may comprise ceramic material. Furthermore, in some embodiments, grooves may be defined in a portion of the fixture comprising ceramic material. In some embodiments, the assembly may be heated to a temperature of at least about 350 degrees Celsius. Additionally, in some embodiments, the assembly may be cured through ultraviolet curing or thermal curing.

In another example embodiment, a method for using a fixture for forming of a fiber assembly is provided. The method comprises positioning a fiber relative to the fixture, and the fixture comprises a movable section configured to move relative to other portions of the fixture.

The method also comprises attaching a first bracket to the fixture at a location away from the movable section to restrain the fiber between the first bracket and the fixture. Additionally, the method comprises attaching a second bracket to the movable section to restrain the fiber between the second bracket and the movable section. The method also comprises adjusting a position of the movable section and the second bracket to adjust a tension level within the fiber.

In some embodiments, the method may also comprise positioning a first tube on the fiber, positioning a second tube on the fiber, injecting epoxy into the first tube, and receiving the second tube within the first tube so that epoxy comes in contact with the first tube and the second tube. Furthermore, in some embodiments, the method may also comprise performing ultraviolet curing or thermal curing to cure the epoxy. In some embodiments, the position of the movable section and the second bracket may be adjusted by removing an end screw from the fixture.

### BRIEF DESCRIPTION OF THE DRAWINGS

Reference will now be made to the accompanying drawings, which are not necessarily drawn to scale, and wherein:

FIG. 1A is a schematic view illustrating a primary tube and a secondary tube of an example fiber assembly, in accordance with some embodiments discussed herein;

FIG. 1B is a perspective view illustrating an example fiber assembly, in accordance with some embodiments discussed herein;

FIG. 2 is a perspective view illustrating an example system for formation of a fiber assembly, in accordance with some embodiments discussed herein;

FIG. 3A is a perspective view illustrating an example system for formation of a fiber assembly where various brackets are not yet positioned in the system, in accordance with some embodiments discussed herein;

FIG. 3B is a top view illustrating the system of FIG. 3A, in accordance with some embodiments discussed herein;

FIG. 3C is an enhanced, top view illustrating the system of FIG. 3B where grooves in the second portion may be seen in greater detail, in accordance with some embodiments discussed herein;

FIG. 4 is a top view illustrating the example system of FIG. 3B where a bracket is used to assist in maintaining a position of the fiber relative to the first portion of the fixture, in accordance with some embodiments discussed herein;

FIG. 5 is a top view illustrating the example system of FIG. 4 where primary tubes and secondary tubes are provided and where fibers extend through cavities of the primary tubes and the secondary tubes, in accordance with some embodiments discussed herein;

FIG. 6 is a top view illustrating the example system of FIG. 5 where a second bracket is used to assist in maintaining a position of the fiber relative to the first portion of the fixture, in accordance with some embodiments discussed herein;

FIG. 7 is a top view illustrating the example system of FIG. 6 where a third bracket is attached to the first portion of the fixture, in accordance with some embodiments discussed herein;

FIG. 8 is a top view illustrating the example system of FIG. 7 where primary tubes are moved along fibers until they contact the bracket introduced in FIG. 7, in accordance with some embodiments discussed herein;

FIG. 9 is a top view illustrating the example system of FIG. 8 where a bracket is attached to the second portion of the fixture to assist in maintaining a position of the primary tubes in relative to the second portion of the fixture, in accordance with some embodiments discussed herein;

FIG. 10A is a perspective view illustrating the example fixture of FIG. 10 where one positioning screw may be seen, in accordance with some embodiments discussed herein;

FIG. 10B is an enhanced, perspective view illustrating the example fixture of FIG. 10A where the engagement of contact pins with primary tubes may be seen, in accordance with some embodiments discussed herein;

FIG. 10C is a perspective view illustrating the example fixture of FIG. 10A where another positioning screw may be seen, in accordance with some embodiments discussed herein;

FIG. 11 is a top view illustrating an example fixture from the system of FIG. 9 after a vacuum fixture has been removed from the fixture, in accordance with some embodiments discussed herein;

FIG. 12 is a perspective view illustrating the example fixture of FIG. 11 received within a heating coil, in accordance with some embodiments discussed herein;

FIG. 13 is a top view illustrating the example fixture of FIG. 12 after the fixture has been removed from the heating coil assembly where the primary tube and the secondary tube on each fiber are moved together, in accordance with some embodiments discussed herein;

FIG. 14A is a perspective view illustrating an example bracket and associated screws and contact pins, in accordance with some embodiments discussed herein;

FIG. 14B is a schematic, cross-sectional view illustrating a portion of the bracket of FIG. 14A, in accordance with some embodiments discussed herein;

FIG. 14C is a perspective view illustrating an example contact pin and an example O-ring, in accordance with some embodiments discussed herein;

FIGS. 15A-15B are varying perspective views illustrating an example system for formation of a fiber assembly where various brackets are positioned in the system, in accordance with some embodiments discussed herein;

FIG. 15C is a side view illustrating the system of FIG. 15A, in accordance with some embodiments discussed herein;

FIG. 15D illustrates the system of FIG. 15A where various brackets are not yet positioned in the system, in accordance with some embodiments discussed herein;

FIG. 16A is a perspective view illustrating an example system for formation of a fiber assembly where various brackets are positioned in the system, in accordance with some embodiments discussed herein;

FIG. 16B is a top view illustrating the system of FIG. 16A before brackets and other tubes are positioned in the system, in accordance with some embodiments discussed herein;

FIG. 16C is a top view illustrating the system of FIG. 16B with a bracket positioned to hold fibers in place, in accordance with some embodiments discussed herein;

FIG. 16D is a top view illustrating the system of FIG. 16C with different tubes moved onto the fibers, in accordance with some embodiments discussed herein;

FIG. 16E is a top view illustrating the system of FIG. 16D with a fourth bracket positioned to further hold the fibers in place, in accordance with some embodiments discussed herein;

FIG. 16F is a top view illustrating the system of FIG. 16E where a block that the fourth bracket is attached to is moved to adjust tension in the fibers, in accordance with some embodiments discussed herein;

FIG. 16G is an, enhanced top view illustrating a bracket of the system of FIG. 16E being used to hold the fibers in place, in accordance with some embodiments discussed herein;

FIG. 16H is a top view illustrating the system of FIG. 16E with further brackets positioned in the system and with primary tubes moved to their appropriate positions, in accordance with some embodiments discussed herein;

FIG. 16I is a perspective view illustrating the system of FIG. 16H positioned within the loops of a heating coil, in accordance with some embodiments discussed herein;

FIG. 16J is an enhanced, top view illustrating the system of FIG. 16I with secondary tubes shifted so that they are received within primary tubes, in accordance with some embodiments discussed herein;

FIG. 17 is a schematic, cross-sectional view illustrating an example screw received within a bracket, in accordance with some embodiments discussed herein;

FIG. 18A is a top view illustrating an example system for formation of a fiber assembly before brackets are positioned in the system but after primary tubes have been positioned, in accordance with some embodiments discussed herein;

FIG. 18B is a top perspective view illustrating the system of FIG. 18A with a tool being used to generally secure a bracket relative to the primary tubes to restrict movement of the primary tubes, in accordance with some embodiments discussed herein;

FIG. 18C is a top perspective view illustrating the system of FIG. 18B with the tool being used to generally secure another bracket relative to the fibers so that the fibers are generally retained in place, in accordance with some embodiments discussed herein;

FIG. 18D is a top perspective view illustrating the system of FIG. 18C with the tool being used to tighten another bracket relative to the fibers so that the fibers are generally secured between the bracket and the fixture, in accordance with some embodiments discussed herein;

FIG. 18E is a top perspective view illustrating the system of FIG. 18D with another tool being used to adjust a tension within the fibers, in accordance with some embodiments discussed herein;

FIG. 18F is a top perspective view illustrating the system of FIG. 18E with a tool being used to generally secure another bracket relative to the fibers, in accordance with some embodiments discussed herein;

FIG. 19A is a schematic view illustrating a primary tube being filled with epoxy using a first approach and a crack that may form in the epoxy when this first approach is taken, in accordance with some embodiments discussed herein;

FIG. 19B is a schematic view illustrating a primary tube being filled with epoxy using a second approach and how cracks may be less likely to form when this second approach is taken, in accordance with some embodiments discussed herein;

FIG. 20 is a block diagram illustrating various components of an example system for formation of a fiber assembly, in accordance with some embodiments discussed herein;

FIG. 21 is a flow chart illustrating an example method using a fixture for forming of a fiber assembly such as a hermetic fiber feedthrough assembly, in accordance with some embodiments discussed herein;

FIG. 22 is a flow chart illustrating an example method of forming a fiber assembly such as a hermetic fiber feedthrough assembly, in accordance with some embodiments discussed herein;

FIG. 23 is a flow chart illustrating an example method of forming a fiber assembly such as a hermetic fiber feedthrough assembly, in accordance with some embodiments discussed herein; and

FIG. 24 is a flow chart illustrating an example method of forming a fiber assembly such as a hermetic fiber feedthrough assembly, in accordance with some embodiments discussed herein.

### DETAILED DESCRIPTION

Example embodiments now will be described more fully hereinafter with reference to the accompanying drawings, in which some, but not all embodiments are shown. Additionally, any connections or attachments may be direct or indirect connections or attachments unless specifically noted otherwise. Furthermore, the use of the terms “primary” and “secondary” are not intended to indicate that one item is greater or lesser or more or less important than another.

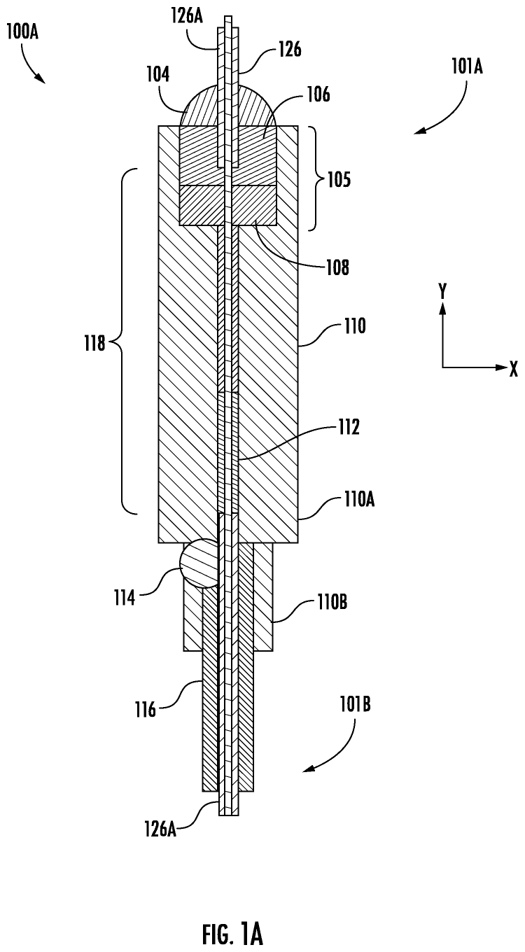

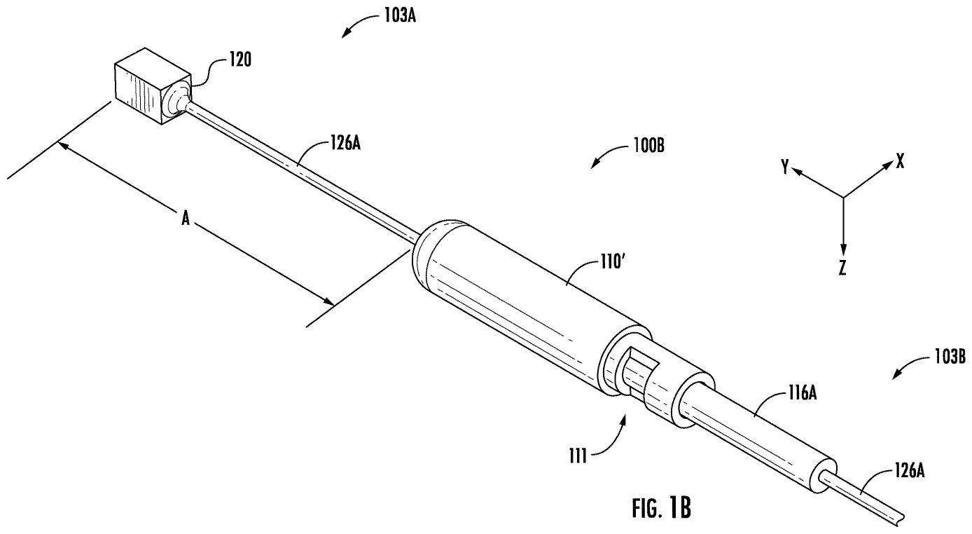

Various embodiments contemplated herein relate to fiber assemblies, and FIG. 1A illustrates a cross-sectional view of primary tube 110 and a secondary tube of an example fiber assembly 100A. The fiber assembly 100A may possess a circular shape centered at the axis formed by the fiber 126, and the cross-section illustrated in FIG. 1A may be rotated about the axis formed by the fiber 126. Other portions of the fiber assembly 100A such as a glass block are not illustrated. The fiber assembly 100A extends in a line parallel to the Y-axis from a first region 101A to a second region 101B. The fiber assembly 100A comprises a fiber 126, a primary tube 110, and a secondary tube 116, and each of the fiber 126, the primary tube 110, and the secondary tube 116 may be circular in shape. The primary tube 110 includes a first section 110A and a second section 110B, with the first section 110A having a greater diameter than the second section 110B. The primary tube 110 defines a hollow shape with a cavity defined in the primary tube 110. Similarly, the secondary tube 116 defines a hollow shape with a cavity defined in the secondary tube 116. The fiber 126 extends through the cavities in the primary tube 110 and the secondary tube 116 as illustrated in FIG. 1A. The secondary tube 116 may extend proximate to the second region 101B of the fiber assembly 100A, and the primary tube 110 may extend proximate to the first region 101A of the fiber assembly 100A. The secondary tube 116 may provide kink protection at the second region 101B of the fiber assembly 100A. Epoxy 114 may be used to facilitate the attachment of the primary tube 110 to the secondary tube 116. The epoxy 114 may include EMI3411 material in some embodiments. Epoxy 114 and other epoxies used herein may have a relatively high glass transition temperature (Tg), which may generally correlate with a higher physical and chemical strength. These higher glass transition temperatures may be obtained by using longer curing times and by using increased curing temperatures for epoxies, and longer curing times and greater curing temperatures may suppress exothermic curing peaks when epoxies are cured.

The fiber 126 may include coating 126A at some portions, but the fiber 126 may have its coating 126A removed along one or more portions of the length of the fiber 126. For example, in FIG. 1A, the fiber 126 has the coating 126A removed in a window stripped area 118, but the fiber 126 has coating 126A present in other portions along the length of the fiber 126.

A glass preform 105 may be positioned within the internal cavity defined in the first section 110A of the primary tube 110. The glass preform 105 may be positioned proximate to the first region 101A of the fiber assembly 100A. This glass preform 105 may include epoxy 106 and glass solder 108. The epoxy 106 may include EMI3411 material in some embodiments. In some embodiments, a strain relief may be positioned in the epoxy 106 to provide strain relief proximate to the first region 101A of the fiber assembly 100A. The glass solder may provide hermetic sealing of the fiber assembly 100A. In some embodiments, the glass preform 105 may have similar thermal expansion properties relative to other components proximate to the glass preform 105 in the fiber assembly 100A, and the glass preform 105 may assist in accomplishing hermetic sealing.

A strain relief 112 may also be positioned within the internal cavity defined in the primary tube 110. The strain relief 112 may act on the fiber 126 to provide strain relief in directions parallel to the Y-axis. However, the strain relief 112 may be positioned at other locations in the fiber assembly 100A.

Kink protection 104 may provide kink protection on the first region 101A of the fiber assembly 100A. The kink protection 104 may be provided in the form of silicon such as room temperature vulcanizing (RTV) silicon in some embodiments, but kink protection 104 may be provided in other forms as well.

Another fiber assembly 100B is illustrated in FIG. 1B, with this fiber assembly 100B being similar to the fiber assembly 100A of FIG. 1A. The fiber assembly 100B extends along a line parallel to the Y-axis in FIG. 1B between a first end 103A and a second end 103B. A fiber 126A extends through cavities of the primary tube 110′ and the secondary tube 116A. The primary tube 110′ may include a window 111 where epoxy or other material may be introduced within the primary tube 110′. This window 111 may be beneficial to introduce epoxy so that the primary tube 110′ and the secondary tube 116A may be fixed relative to each other. The fiber 126A extends to a glass block 120 at the first end 103A, and the fiber 126A may be attached to the glass block 120. The glass block 120 may possess a beveled edge in some embodiments. Where this is the case, the glass block may be positioned so that the beveled edge is positioned and/or oriented appropriately relative to a fixture or a sink formed in the fixture. The fiber assembly 100B may define a distance A from the primary tube 110′ to the farthest part of the glass block 120 at the first end. The distance A may be adjusted to meet the particular needs for a given application.

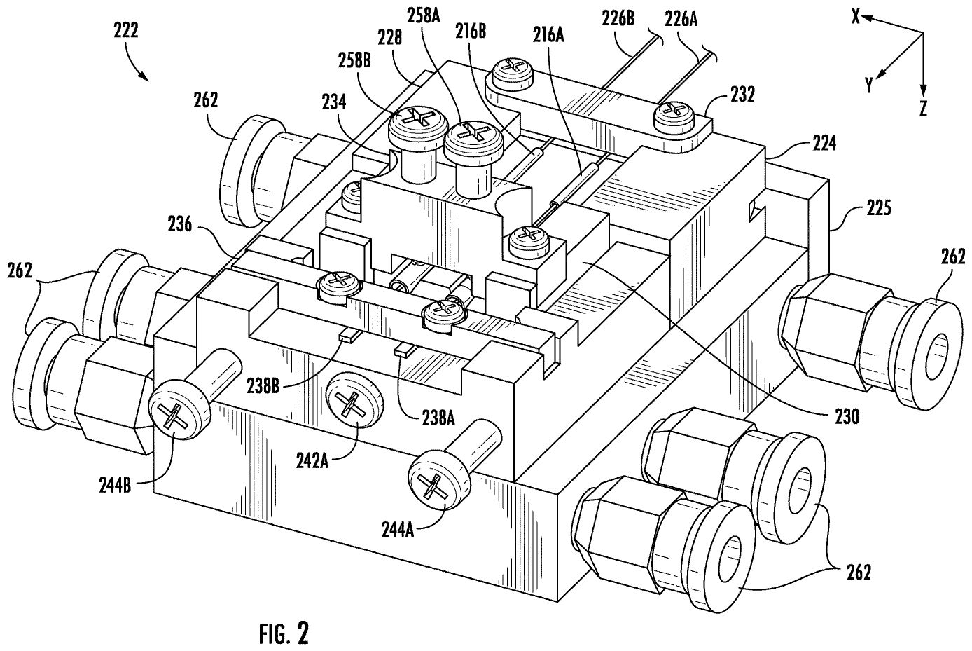

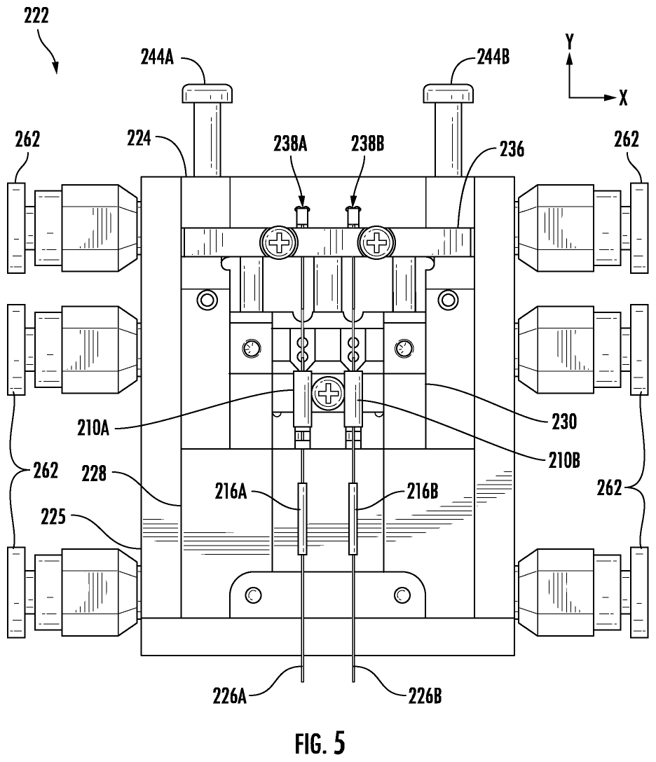

Various embodiments contemplated herein relate to systems and fixtures for formation of fiber assemblies. FIG. 2 illustrates one example system 222 for formation of a fiber assembly. The system 222 comprises a fixture 224, and the fixture 224 comprises a first portion 228 and a second portion 230. The system 222 also comprises a first fiber 226A and a second fiber 226B, but other systems 222 may include one or more fibers in other embodiments. The system 222, with reference to FIG. 5, also comprises a primary tube 210A and a primary tube 210B, but the system may comprise a different number of these tubes in other embodiments. The fixture 224 may comprise materials with a high temperature resistance, and the fixture 224 may also comprise non-induction materials such as glass, engineering plastics (e.g., polyimide (PI), polyetherimide (PEI), polyetheretherketone (PEEK), etc.), ceramics, etc.

The first portion 228 of the fixture 224 is configured to be fixed relative to the fibers 226A, 226B. This may be accomplished through the use of one or more brackets. For example, a bracket 232 is configured to attach the fibers 226A, 226B to the first portion 228 at one location, and a bracket 236 is configured to attach the fibers 226A, 226B to the first portion 228 at another location.

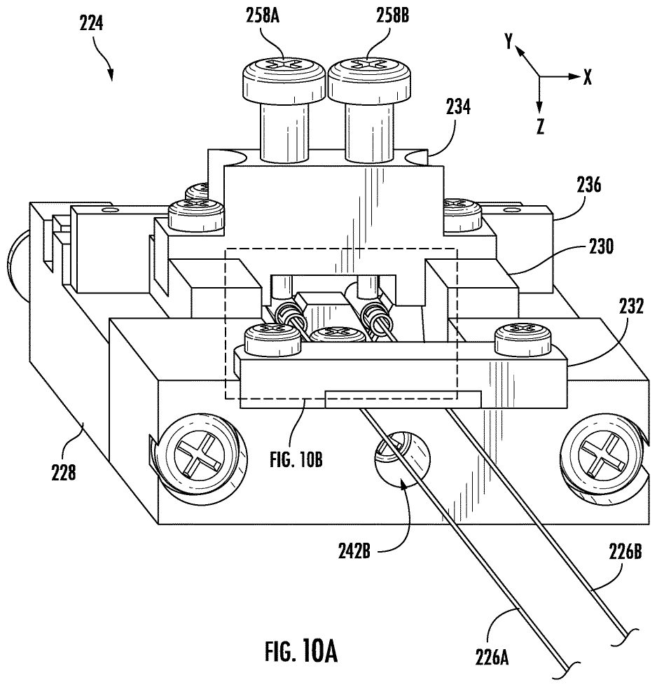

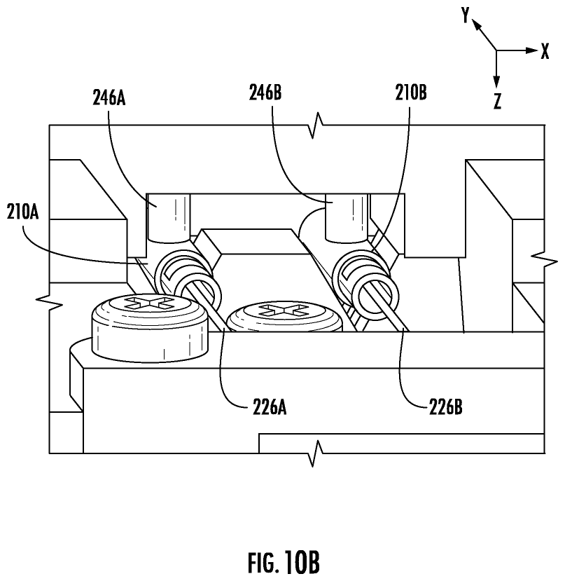

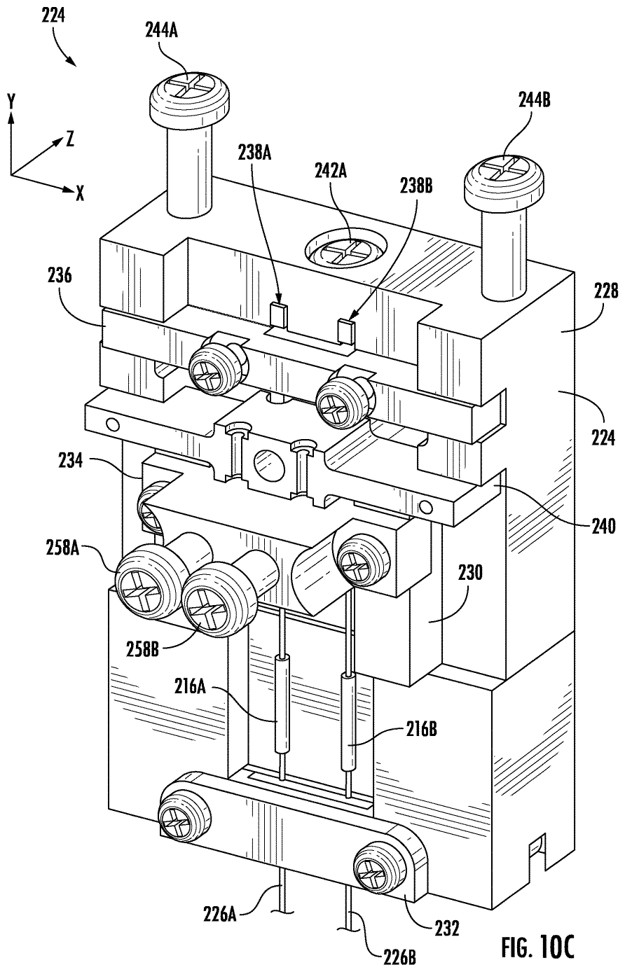

The second portion 230 of the fixture is configured to be fixed relative to the primary tubes 210A, 210B. This may be accomplished through the use of one or more brackets. For example, a bracket 234 is configured to be attached to the second portion 230, and the bracket 234 may facilitate the attachment of screws 258A, 258B. These screws 258A, 258B may engage contact pins 246A, 246B (see FIG. 10B, 14B), urging the contact pins 246A, 246B into the primary tubes 210A, 210B. With sufficient force applied by the screws 258A, 258B to the contact pins 246A, 246B, the contact pins 246A, 246B restrain the movement of the second portion 230 relative to the primary tubes 210A, 210B so that movement of the second portion 230 (e.g., in a direction parallel to the Y-axis) causes a reciprocal movement in the primary tubes 210A, 210B. This movement of the second portion 230 may also cause movement of a respective tubes of the primary tubes 210A, 210B relative to the associated fiber of the fibers 226A, 226B. Screws 258A, 258B may comprise plastic material in some embodiments, but the screws 258A, 258B may comprise other materials in other embodiments.

The second portion 230 may comprise one or more grooves therein, and the second portion 230 may be configured to receive the primary tubes 210A, 210B in the grooves. In some embodiments, there may be two grooves, with the primary tube 210A being received in a first groove and with the primary tube 210B being received in the second groove. However, a different number of grooves may be provided in other embodiments. The number of grooves may match the number of tubes in some embodiments. Thus, where three tubes similar to primary tubes 210A, 210B are provided, then three grooves may be provided. The grooves may be V-grooves in some embodiments. This may be beneficial because the V-grooves may have a relatively small contact area with the primary tubes 210A, 210B. As a result, the primary tubes 210A, 210B may retain more heat during glass soldering as less heat may be thermally conducted through the smaller contact area with the V-grooves.

The second portion 230 is configured to move relative to the first portion 228. Movement of the second portion 230 relative to the first portion 228 causes movement of the primary tubes 210A, 210B relative to the fibers 226A, 226B, allowing for adjustability to the desired fiber assembly configuration. Thus, the second portion 230 may be adjusted in position relative to the first portion 228 so that the primary tubes 210A, 210B are positioned as desired relative to the fibers 226A, 226B.

Additional tubes may be provided to offer further protection for fibers 226A, 226B. In FIG. 2, a secondary tube 216A is provided on the fiber 226A, and a secondary tube 216B is provided on the fiber 226B. The secondary tubes 216A, 216B may be hollow and may define a cavity therein where a respective fiber of the fibers 226A, 226B may be received. In some embodiments, secondary tubes 216A, 216B of differing sizes and shapes may be used to accomplish the desired properties for a final fiber assembly that is assembled.

The system 222 also comprises a vacuum fixture 225. The vacuum fixture 225 is configured to supply one or more suction forces to assist in maintaining positioning and/or orientations of the primary tubes 210A, 210B, the fibers 226A, 226B, and the fixture 224 relative to each other. The vacuum fixture 225 may include one or more vacuum ports 262. In the illustrated embodiment, the vacuum fixture 225 includes six vacuum ports 262, but a different number of vacuum ports 262 may be included in other embodiments. The vacuum fixture 225 may be removably attachable from the fixture 224. In some embodiments, the vacuum fixture 225 may be removably attachable to the first portion 228 of the fixture 224, but the vacuum fixture 225 may be attached to the second portion 230 or to another part of the fixture 224.

The system 222 also includes a first positioning screw 242A and a second positioning screw 242B (see FIG. 10A). The positioning screws 242A, 242B may be threaded, and the positioning screws 242A, 242B may extend through respective holes within the first portion 228 of the fixture 224. The positioning screws 242A, 242B may extend to one or more holes within the second portion 230, and these hole(s) of the second portion 230 may be threaded. As the positioning screw 242A is rotated, threads of the positioning screw 242A may engage threads of a hole of the second portion 230 to cause the second portion 230 to move in a direction parallel to the Y-axis in FIG. 10C relative to the first portion 228. Similarly, as the positioning screw 242B is rotated, threads of the positioning screw 242B may engage threads of a hole of the second portion 230 to cause the second portion 230 to move in a direction parallel to the Y-axis in FIG. 10C relative to the first portion 228. The head of the positioning screws 242A, 242B may engage the first portion 228 of the fixture 224. Thus, the positioning screws 242A, 242B may be used to adjust the position of the second portion 230 relative to the first portion 228. The position of the second portion 230 may be adjusted to accomplish the required fiber length to meet product requirements. For example, adjustment of the position of the second portion 230 may change the distance A (see FIG. 1B) for a resulting fiber assembly 100B (see FIG. 1B) from a primary tube to the end of the fiber assembly.

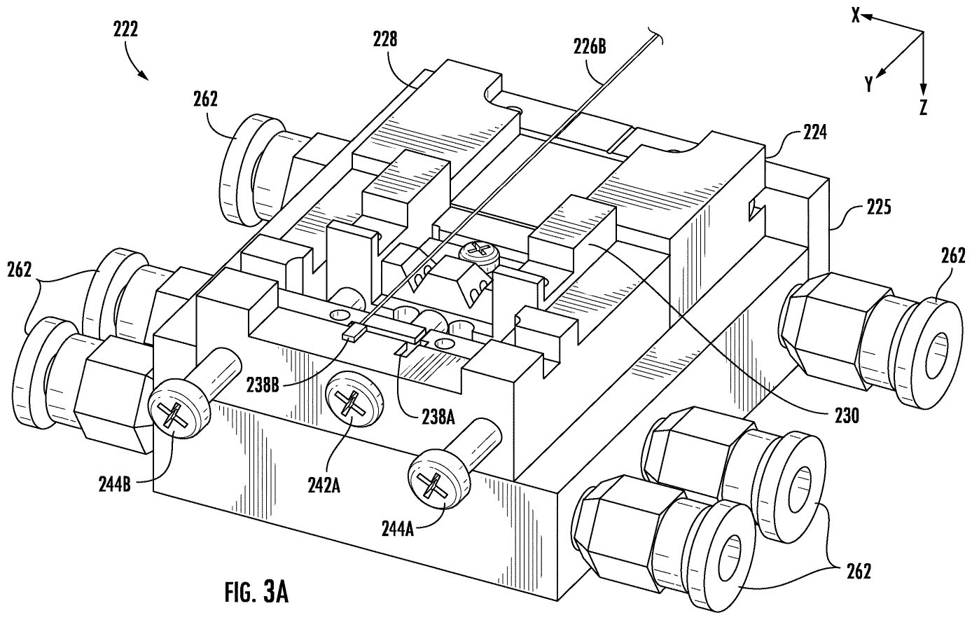

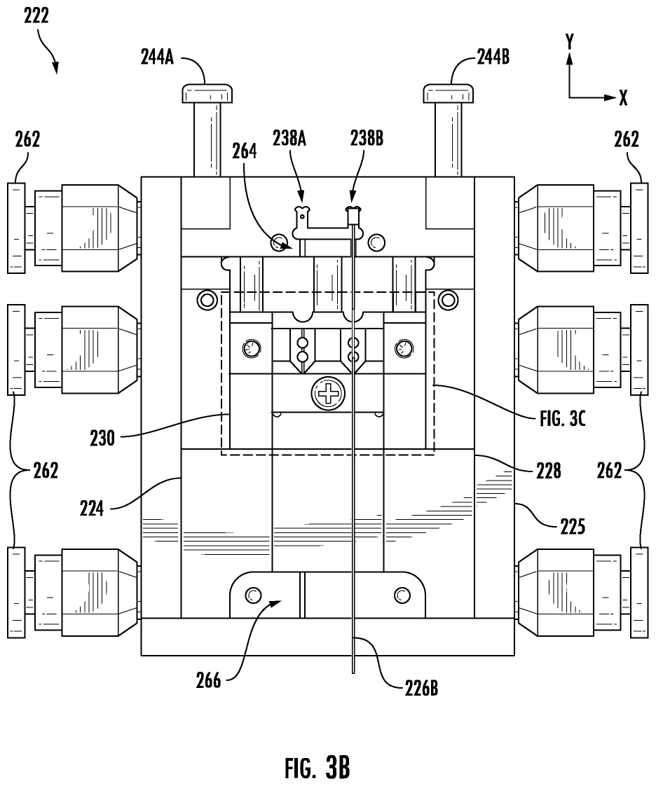

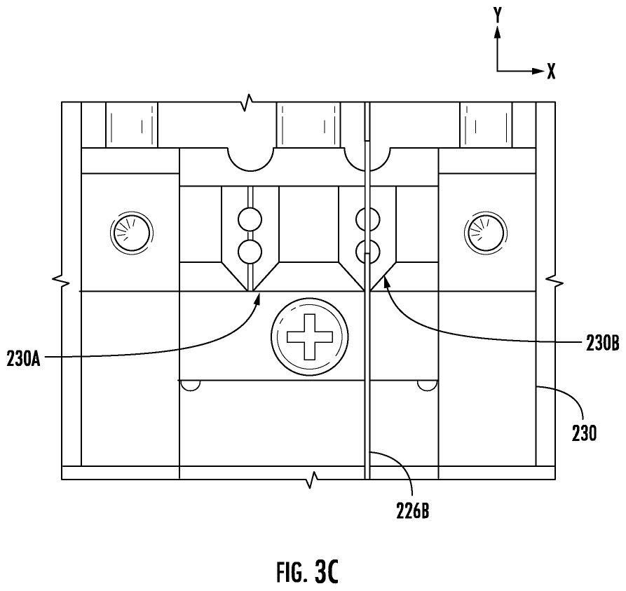

Various embodiments also relate to methods for making fiber assemblies using different fixtures and systems, and FIG. 3A through FIG. 13 illustrate systems at various stages of the manufacturing processes for making a fiber assembly. FIG. 3A is a perspective view illustrating an example system for formation of a fiber assembly where various brackets of the system are not yet positioned in the system, and FIG. 3B is a top view illustrating the same. Additionally, FIG. 3C is an enhanced, top view allowing grooves in the first portion to be seen in greater detail.

In FIGS. 3A-3C, the system 222 is provided without the brackets 232, 234, 236 illustrated in FIG. 2. The system 222 in FIGS. 3A-3C includes the fixture 224 comprising the first portion 228 and the second portion 230. For the purposes of illustration, the system 222 illustrates only a second fiber 226B in FIGS. 3A-3C, but a first fiber 226A may also be added as illustrated in FIG. 2.

The vacuum fixture 225 is attached to the fixture 224 in FIGS. 3A-3C. The fixture 224 and the vacuum fixture 225 may be removably attachable to each other in some embodiments. Thus, the fixture 224 may be separated from the vacuum fixture 225 when desirable, such as to allow additional processing steps to be performed on the fixture 224 and other components in isolation from the vacuum fixture 225. The vacuum fixture 225 may receive vacuum suction at one or more of the vacuum ports 262, and this vacuum suction may be used to assist in maintaining a position and/or or orientation of the fibers 226A, 226B. Suction forces may be applied at a variety of locations on the fixture 224. For example, suction forces may be applied proximate to the sinks 238A, 238B, at a location 264 proximate to each fiber 226A, 226B, and at a location 266 proximate to each fiber 226A, 226B. Once the fibers 226A, 226B are positioned appropriately, vacuum suction may be applied through small holes to help retain the fibers 226A, 226B or the glass blocks attached to the fibers 226A, 226B in the same position and/or orientation.

A glass block may be positioned at the sink 238A, and another glass block may be positioned at the sink 238B. These glass blocks may be similar to the glass block 120 of FIG. 1B. As illustrated in FIG. 3C, fiber 226B may be positioned at groove 230B. The fiber 226A may also be added and positioned at groove 230A in a similar manner. The grooves 230A, 230B may be formed in walls at the second portion 230, and the walls that form the grooves 230A, 230B may comprise glass material, engineered plastics such as polyimide (PI), polyetherimide (PEI), polyetheretherketone (PEEK), etc., and other materials.

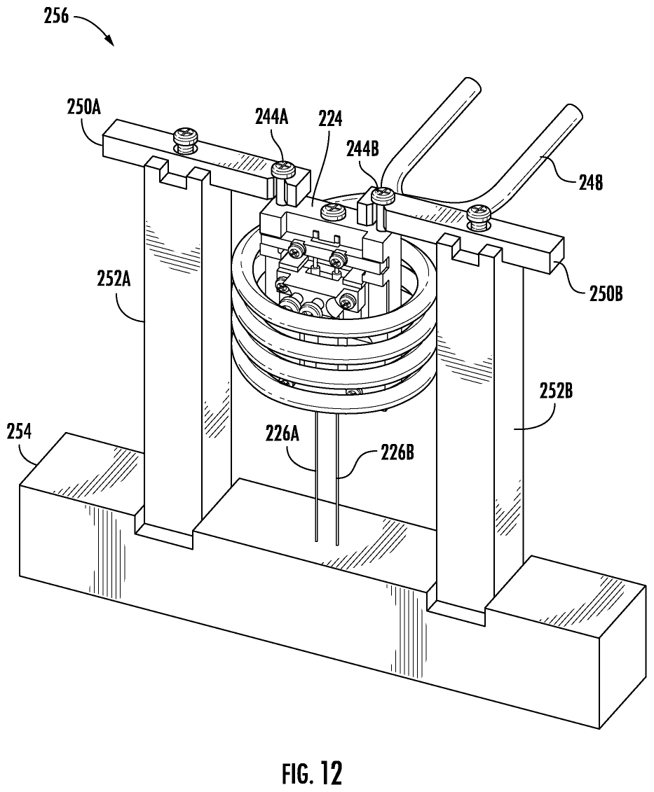

As discussed further herein, the system 222 also includes a positioning screw 242A, and the positioning screw 242A may engage the second portion 230 to adjust the position of the second portion 230 relative to the first portion 228 in a direction parallel to the Y-axis. Additionally, as discussed further herein, the system 222 also includes mounting screws 244A, 244B, and these mounting screws 244A, 244B may be used to mount the fixture 224 relative to other components such as the heating coil assembly 256 of FIG. 12. However, various other mechanisms may be used to mount the fixture 224.

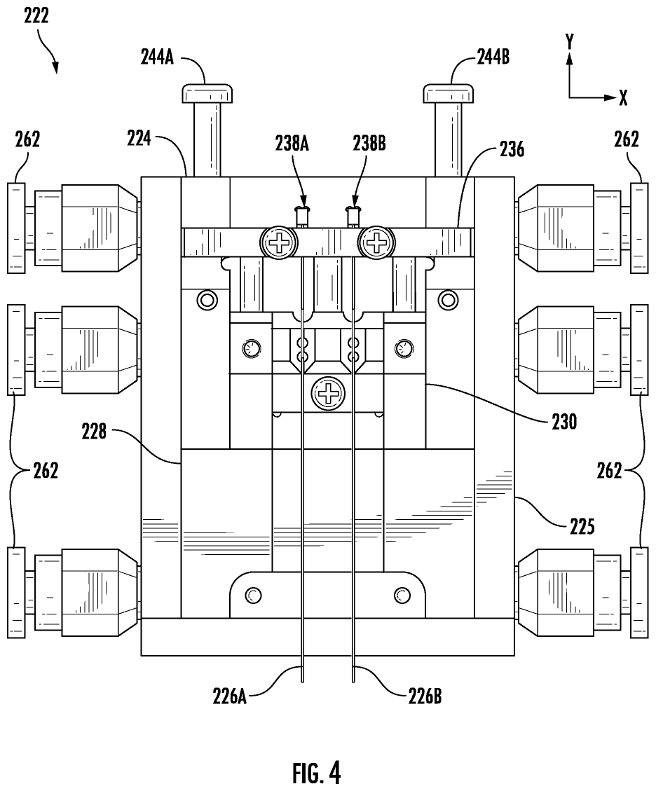

FIG. 4 illustrates the example system 222 of FIG. 3B where a bracket 236 is provided. The bracket 236 may be configured to assist in fixing the first portion 228 relative to the fibers 226A, 226B. The bracket 236 is attached to the first portion 228 to restrict the movement of the fibers 226A, 226B. Fasteners such as screws may be utilized to facilitate the attachment of the bracket 236 to the first portion 228 of the fixture 224.

FIG. 5 illustrates the example system 222 of FIG. 4 where primary tubes 210A, 210B and the secondary tubes 216A, 216B are added and where fibers 226A, 226B extend through cavities of the primary tubes 210A, 210B and the cavities of the secondary tubes 216A, 216B. The size and shape of the primary tubes 210A, 210B and the secondary tubes 216A, 216B may be selected to meet the design requirements for the final fiber assembly. The primary tubes 210A, 210B and the secondary tubes 216A, 216B may be added on the fibers 226A, 226B by inserting an end of the fibers in these tubes and then moving these tubes along the Y-direction towards the sinks 238A, 238B (e.g., upwardly from the perspective illustrated in FIG. 5). In some embodiments, the fibers 226A, 226B may have primary tubes 210A, 210B and/or secondary tubes 216A, 216B already positioned on the fibers 226A, 226B when the fibers 226A, 226B are first introduced. In some embodiments, the primary tubes 210A, 210B may have glass preforms positioned within the internal cavities of the primary tubes 210A, 210B. However, the glass preforms may be positioned at other locations or in other components in other embodiments. The glass preforms may be similar to glass preforms 105 of FIG. 1B.

The system 222 comprises two primary tubes 210A, 210B, but the system 222 may comprise a different number of these tubes in other embodiments. The primary tubes 210A, 210B each define a cavity within the primary tubes 210A, 210B, and each of the primary tubes 210A, 210B are configured to receive a respective fiber of the fibers 226A, 226B in the cavity of the primary tubes 210A, 210B. The primary tubes 210A, 210B and other primary tubes described herein may be Kovar® tubes in some embodiments. Kovar® tubes may be beneficial as they may possess a coefficient of thermal expansion that is similar to the coefficient of thermal expansion for fibers 226A, 226B. However, primary tubes 210A, 210B may also take on other forms other than Kovar® tubes. The primary tubes 210A, 210B and other primary tubes described herein may comprise a metal material such as iron nickel cobalt alloys or Fernico metals, but the primary tubes may comprise other materials in other embodiments. In some embodiments, the size and shape of primary tubes may be selected to meet the requirements for a final fiber assembly that is assembled. In some embodiments, the secondary tubes 216A, 216B and any other secondary tubes described herein may have an external diameter of about 900 micrometers, and the bare fibers 226A, 226B may have a diameter of about 250 micrometers. The primary tubes 210A, 210B and the secondary tubes 216A, 216B may also assist in keeping the fibers 226A, 226B straight in some embodiments.

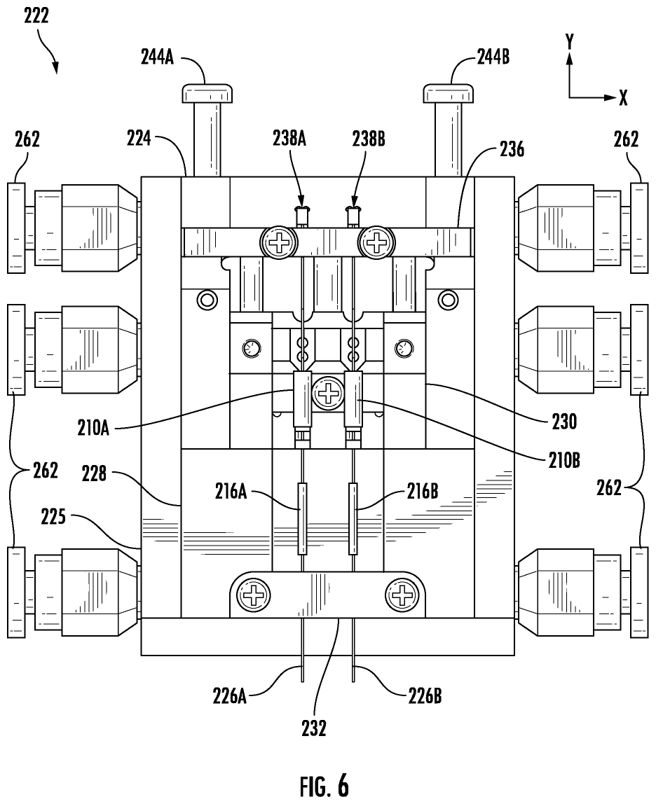

FIG. 6 illustrates the example system 222 where a bracket 232 is provided. The bracket 232 may be configured to assist in fixing the first portion 228 relative to the fibers 226A, 226B. The bracket 232 is attached to the first portion 228 to restrict the movement of the fibers 226A, 226B. Fasteners such as screws may be utilized to facilitate the attachment of the bracket 232 to the first portion 228 of the fixture 224.

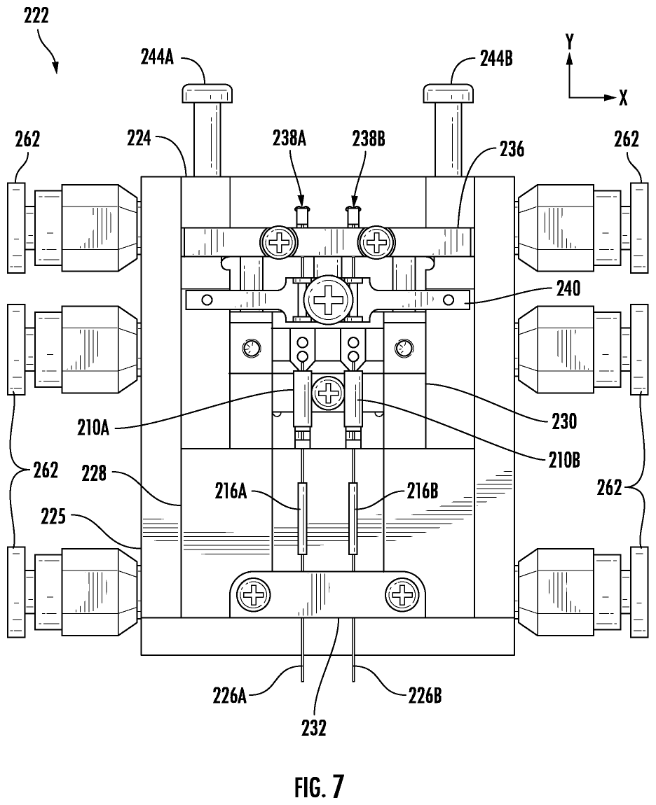

FIG. 7 illustrates the example system 222 where a bracket 240 has been added. The bracket 240 may be configured to assist in positioning the primary tubes 210A, 210B. The bracket 240 may be attached to the first portion 228 of the fixture 224.

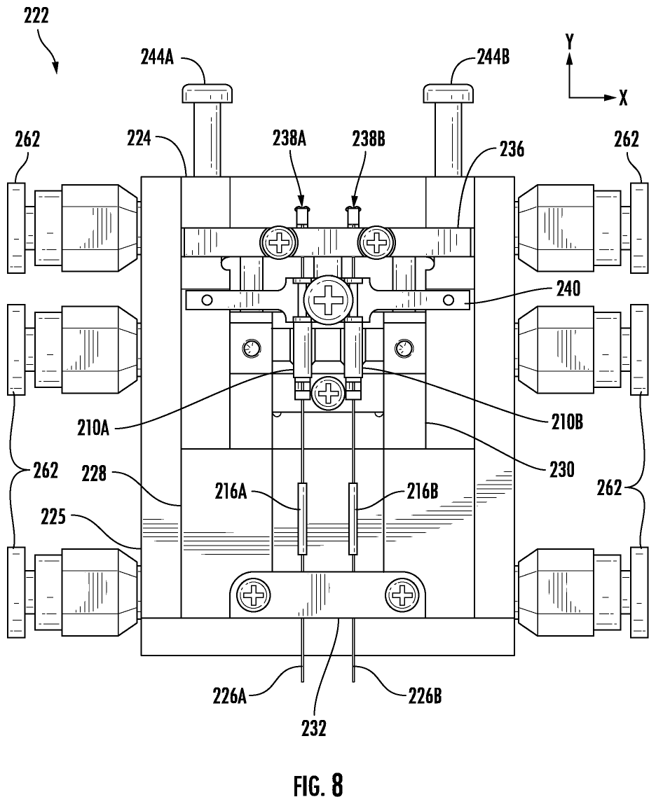

FIG. 8 illustrates the example system 222 where primary tubes 210A, 210B are moved along fibers 226A, 226B until they contact the bracket 240. At this stage, the primary tubes 210A, 210B may be allowed to freely move in directions parallel to the Y-axis. Thus, the primary tubes 210A, 210B may be moved in a direction parallel to the Y-axis towards the sinks 238A, 238B. Movement of the primary tubes 210A, 210B may be accomplished using suction forces from the vacuum fixture 225 (e.g., by redirecting suction force and/or by deactivating certain suction force and activating certain other suction force (e.g., closer to the desired resting position)). Upon contacting the bracket 240, the primary tubes 210A, 210B may be in the appropriate position along the Y-axis, and the primary tubes 210A, 210B may also rest in the grooves to generally maintain the position of the primary tubes 210A, 210B in other directions. In some embodiments, the position of the bracket 240 may be selected to optimize the soldering for sealing.

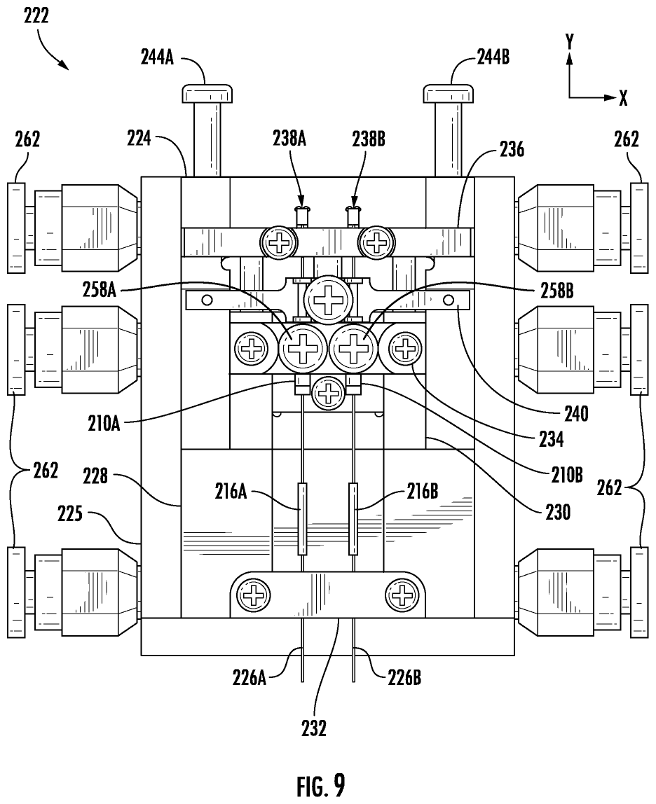

FIG. 9 illustrates the example system 222 where a bracket 234 is added. The bracket 234 is attached to the second portion 230 of the fixture 224. Some fasteners in the form of screws may be used to assist in attaching the bracket 234 to the second portion 230. The bracket 234 may assist in fixing the primary tubes 210A, 210B relative to the second portion 230 of the fixture 224 once the primary tubes 210A, 210B are positioned appropriately.

Further details regarding the operation of the bracket 234 may be understood by viewing FIGS. 10A and 10B. The bracket 234 is configured to receive two contact pins 246A, 246B therein, and these contact pins 246A, 246B are each configured to be urged against a respective tube of the primary tubes 210A, 210B. As illustrated in FIG. 10B, the contact pin 246A is being urged against the primary tube 210A, and the contact pin 246B is being urged against the primary tube 210B. The contact pins 246A, 246B may be urged against the primary tubes 210A, 210B due to the forces applied on the contact pins 246A, 246B by the screws 258A, 258B. The screws 258A, 258B may be adjusted in directions parallel to the Z-axis in FIG. 10A. Adjustment of the screw position closer to the primary tubes 210A, 210B generates a greater amount of force on the contact pins 246A, 246B, and this increased amount of force generates an increased amount of friction between the contact pins 246A, 246B and the primary tubes 210A, 210B. Eventually, the force applied by the contact pins 246A, 246B may be sufficient together with other friction forces acting on the primary tubes 210A, 210B (e.g., which may be provided from the walls of grooves 230A, 230B) to cause the motion of the primary tubes 210A, 210B to be fixed relative to the second portion 230 of the fixture 224 and relative to the bracket 234. Thus, movement of the second portion 230 along the Y-axis may cause a similar amount of movement along the Y-axis by the bracket 234, the screws 258A, 258B, the contact pins 246A, 246B, and the primary tubes 210A, 210B. The contact pins 246A, 246B may comprise ceramic material in some embodiments, but the contact pins 246A, 246B may comprise other materials in other embodiments.

As illustrated in FIGS. 10A and 10C, the system 222 includes a first positioning screw 242A and a second positioning screw 242B. The positioning screws 242A, 242B may be threaded, and the positioning screws 242A, 242B may extend through respective holes within the first portion 228 of the fixture 224. The positioning screws 242A, 242B may extend to one or more holes within the second portion 230, and these hole(s) of the second portion 230 may be threaded. As the positioning screw 242A is rotated, threads of the positioning screw 242A may engage threads of a hole of the second portion 230 to cause the second portion 230 to move in a direction parallel to the Y-axis in FIG. 10C relative to the first portion 228. Similarly, as the positioning screw 242B is rotated, threads of the positioning screw 242B may engage threads of a hole of the second portion 230 to cause the second portion 230 to move in a direction parallel to the Y-axis in FIG. 10C relative to the first portion 228. The head of the positioning screws 242A, 242B may engage the first portion 228 of the fixture 224. Thus, the positioning screws 242A, 242B may be used to adjust the position of the second portion 230 relative to the first portion 228.

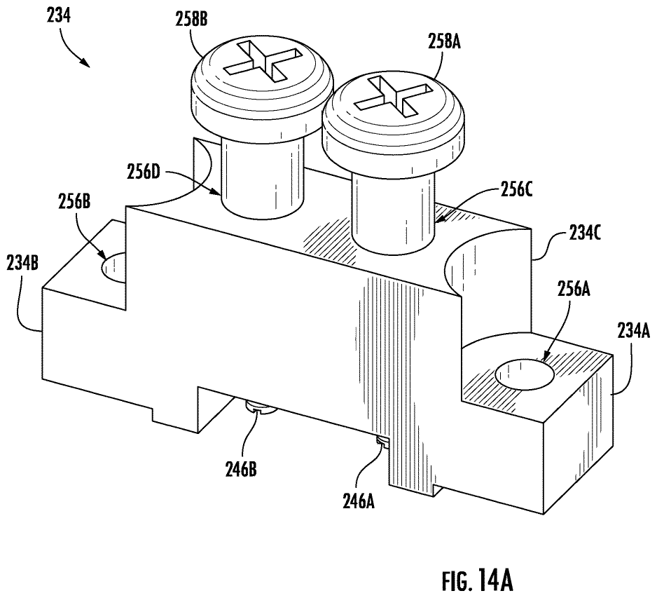

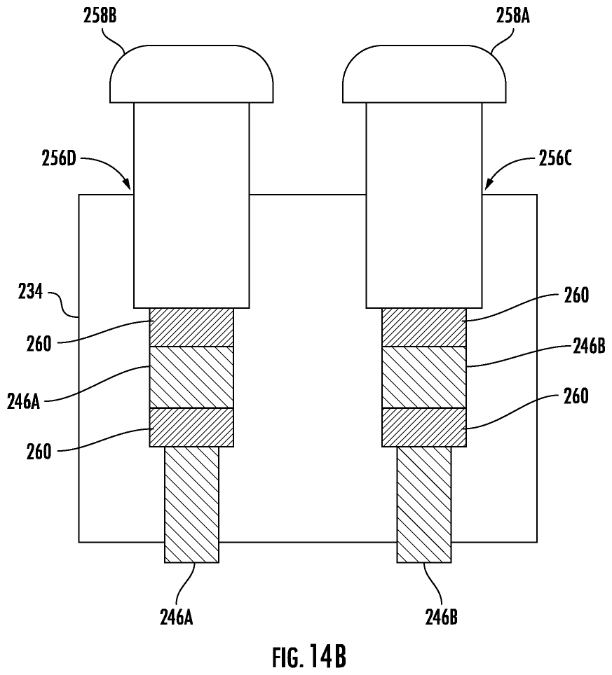

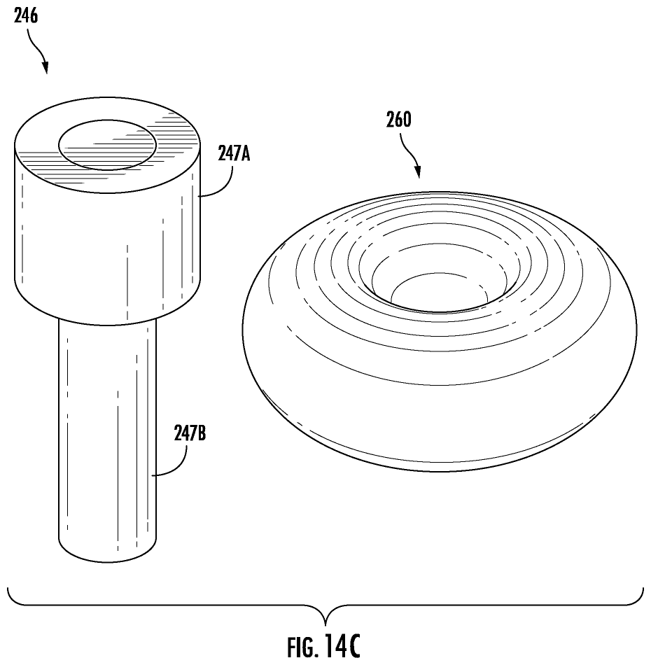

Looking ahead to FIGS. 14A-14C, further details may be seen regarding the bracket 234. The bracket 234 may include a first section 234A, a second section 234B, a third section 234C. The third section 234C is positioned between the first section 234A and the second section 234B. A first hole 256A is positioned at the first section 234A, and a second hole 256B is positioned at the second section 234B. The first hole 256A and the second hole 256B may be configured to receive fasteners such as screws to facilitate attachment of the bracket 234 to the second portion 230 of the fixture 224.

The third section 234C of the bracket 234 includes a third hole 256C and a fourth hole 256D. The third hole 256C may be configured to receive a first screw 258A, and the fourth hole 256D may be configured to receive a second screw 258B. The screws 258A, 258B may be adjusted in position relative to the bracket 234 to generate a greater or lesser amount of force on the contact pins 246A, 246B. This may be seen in greater detail in the schematic, cross-sectional view of FIG. 14B. FIG. 14B shows a portion of the bracket 234 where the cross-section of the third hole 256C and the fourth hole 256D are visible. The diameter of the holes 256C, 256D may be larger where the screws 258A, 258B are introduced, and the diameter of the holes 256C, 256D may be reduced in size at positions where contact pins 246A, 246B are located. The screws 258A, 258B may be adjusted in position to generate a greater or lesser amount of force on the contact pins 246A, 246B as discussed herein. One or more o-rings 260 may be provided in the holes 256C, 256D. The o-rings may provide an elastic force to urge the screws 258A, 258B away from the contact pins 246A, 246B when the screws 258A, 258B are loosened. The contact pins 246A, 246B extend through central cavities of the o-rings 260 in FIG. 14B.

An example contact pin 246 and an example o-ring 260 are illustrated in FIG. 14C. In the example contact pin 246, the contact pin 246 includes a first portion 247A and a second portion 247B. The first portion 247A may comprise an engineered plastic such as polyimide (PI), polyetherimide (PEI), polyetheretherketone (PEEK), etc., but other materials may be used in the first portion 247A. Material in the first portion 247A may have a high temperature resistance, and this may be beneficial to allow the contact pins 246 to be thermally cured using the heating coil assembly 256 of FIG. 12. In some embodiments, the first portion 247 comprises ceramic material, but the first portion 247 may comprise different materials in other embodiments. The second portion 247B may comprise a ceramic material, and the second portion 247B may be provided in the shape of a pin. This material may also allow the second portion 247B to be thermally cured using the heating coil assembly 256 of FIG. 12. The o-ring 260 may comprise an elastic material such as silicone in some embodiments, but the o-ring 260 may comprise other materials in other embodiments.

Additionally, in FIGS. 10A-10C, the vacuum fixture 225 is separated from the fixture 224. The fixture 224 and the vacuum fixture 225 may be removably attachable to each other in some embodiments. Thus, the fixture 224 may be separated from the vacuum fixture 225 when needed to allow additional processing steps to be performed on the fixture 224 in isolation.

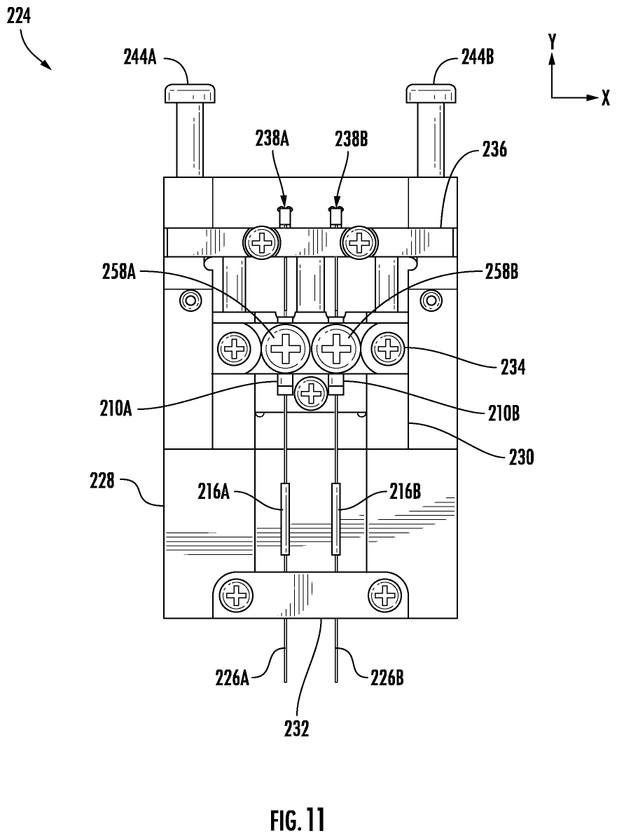

In FIG. 11, the bracket 240 has been removed from the fixture 224, but the bracket 240 may be retained on the fixture 224 during heating of the fixture 224 in some embodiments.

As illustrated in FIG. 12, the fixture 224 may then be received within a heating coil 248 of a heating coil assembly 256. The fixture 224 may be attached to the heating coil assembly 256 using the mounting screws 244A, 244B. The mounting screws 244A, 244B may facilitate the attachment of the mounting screws 244A, 244B to the top members 250A, 250B of the heating coil assembly 256. The top members 250A, 250B may be attached to the towers 252A, 252B of the heating coil assembly 256, and the towers 252A, 252B may be attached to the base 254 of the heating coil assembly 256. The heating coil assembly 256 may also include a heating coil 248, and the heating coil 248 may be an induction heating coil in some embodiments. The heat from the heating coil 248 may heat the primary tubes 210A, 210B, which may comprise metal material. This heating coil 248 wraps around in four loops, and the fixture 224 may be positioned in the volume within these four loops so that the fixture 224 and the components on the fixture 224 may be heated. The heating coil assembly 256 may be used to thermally cure the fixture 224 and other components on the fixture 224 such as the primary tubes 210A, 210B and the fibers 226A, 226B. Thermal curing of the fixture 224, the fibers 226A, 226B, and the primary tubes 210A, 210B may be accomplished by heating these components with the heating coil 248. In some embodiments, thermal curing may occur at a temperature between about 325 degrees Celsius and about 400 degrees Celsius, or thermal curing may occur at a temperature between about 350 degrees Celsius and about 375 degrees Celsius. Additionally, in some embodiments, thermal curing may occur for a time between about 50 seconds and about 160 seconds, or thermal curing may occur for a time between about 60 seconds and about 150 seconds. The temperature and curing time may be effectively controlled between different fiber assemblies to ensure consistency in the performance, strength, and other characteristics of the fiber assemblies. However, the thermal curing properties may be different in other embodiments, and thermal curing properties may rely on the characteristics of glass soldering materials. By positioning the fixture 224 within the heating coil 248 and heating the fixture 224 and the components thereon, components may be glass soldered. In some embodiments, the fixture 224 and other components that are heated may generally possess similar thermal expansion properties.

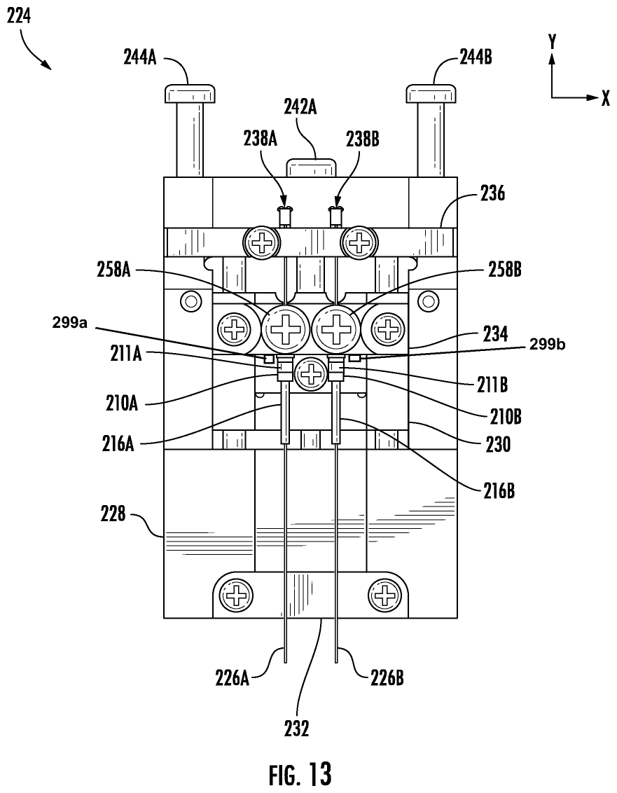

One or more thermal sensors may be used to monitor the temperature in the heating coil assembly 256, the fixture 224, and/or the components on the fixture 224. The thermal sensors may include thermocouples in some embodiments, but other types of thermal sensors may also be utilized. In some embodiments, the thermal sensors may be positioned proximate to the primary tubes 210A, 210B. In an example embodiment, FIG. 13 illustrates two thermal sensors 299a, 299b that are positioned against the bracket 234 to monitor the temperature at this location of the thermal sensors. Once heating of the fixture 224 is completed, the fixture 224 may be removed from the heating coil assembly 256, and the fixture 224 may be placed in a horizontal position (e.g., so that the X-Y plane in FIG. 13 is the horizontal plane).

FIG. 13 illustrates the example fixture 224 after the fixture 224 has been removed from the heating coil assembly 256 and where tubes on each fiber are moved together. For example, on the fiber 226A, the secondary tube 216A is moved towards the primary tube 210A. Additionally, on the fiber 226B, the secondary tube 216B is moved towards the primary tube 210B.

Epoxy may be configured to assist in positioning components relative to each other. For example, the epoxy may be configured to assist in attaching the secondary tube 216A to the primary tube 210A, and the epoxy may also be configured to assist in attaching the secondary tube 216B to the primary tube 210B. The epoxy may be added at the primary tubes 210A, 210B. Epoxy may be positioned at the primary tubes 210A, 210B by positioning the epoxy within cavities formed within the primary tubes 210A, 210B, by positioning epoxy at locations proximate to the primary tubes 210A, 210B, and/or by positioning epoxy at the ends of the primary tubes 210A, 210B. In some embodiments, the primary tubes 210A, 210B may comprise one or more windows 211A, 211B at locations between the first end and the second end of the primary tubes 210A, 210B. The windows 211A, 211B may provide one or more openings where epoxy may be introduced to the cavities within the primary tubes 210A, 210B. After epoxy is introduced, the fixture 224, certain components on the fixture 224 such as the primary tubes 210A, 210B, or the newly added epoxy may undergo ultraviolet curing. The fixture 224 and other components thereon may also be thermally cured by placing the fixture 224 in an oven. EMI3411 material may be utilized as an epoxy in some embodiments, but other epoxies may also be used.

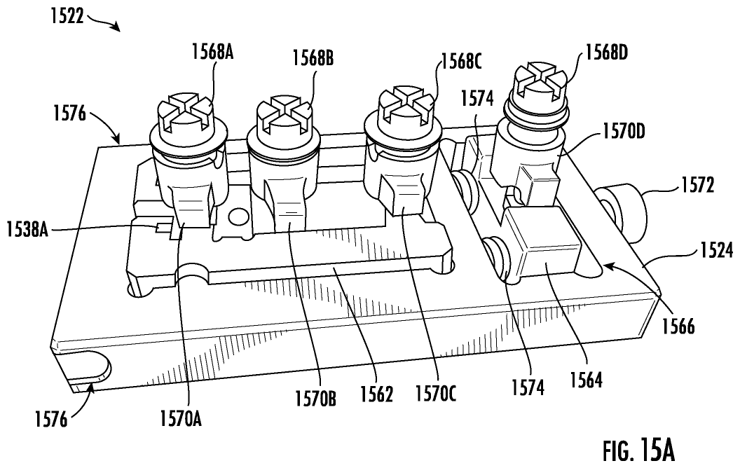

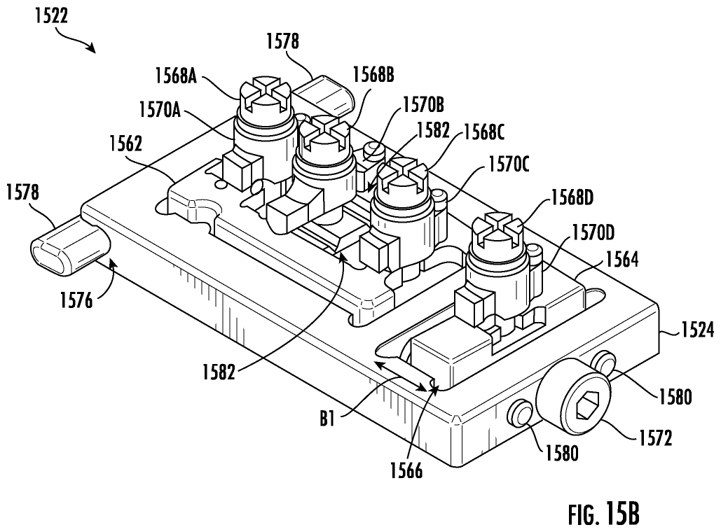

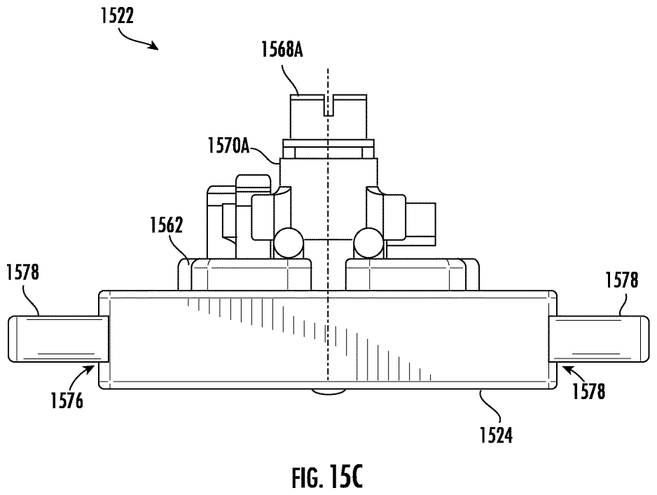

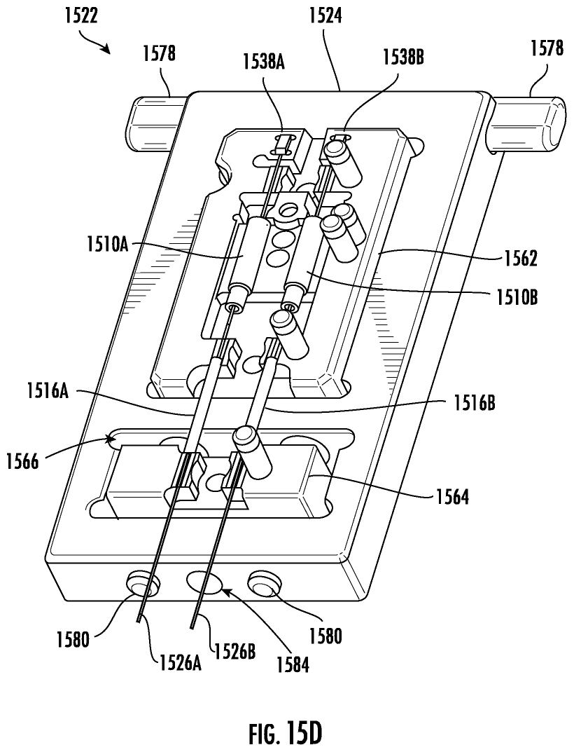

Another example system 1522 for formation of a fiber assembly is illustrated in different perspective views in FIGS. 15A-15B with various brackets being visible, and FIG. 15C is a side view illustrating the system 1522 of FIG. 15A. While primary tubes, secondary tubes, and fibers of the system 1522 are now shown in FIGS. 15A-15C, these features are visible in FIG. 15D. The system 1522 may allow the fiber tension to be effectively controlled so that more effective fiber assemblies may be formed. The fixture 1524 of the system 1522 may also comprise ceramic material, allowing the fixture 1524 to better withstand repeated use in harsh conditions.

The system 1522 includes a fixture 1524. The fixture 1524 comprises a section 1562 and a section 1564. The fixture 1524 also defines an internal recess 1566, and section 1564 is received within the internal recess 1566. The section 1562 generally remains fixed in place relative to the surrounding portions of the fixture 1524.

However, the section 1564 may be allowed to move relative to surrounding portions of the fixture 1524 as indicated by the arrowed line B1. The fixture 1524 defines an end hole 1584. This end hole 1584 may be configured to receive an end screw 1572 so that the end screw 1572 may extend to the section 1564 and engage the section 1564. As a result of this engagement, a user may rotate the end screw 1572 to adjust the position of the section 1564 relative to the remainder of the fixture 1524. Guide rails 1580 are also provided. These guide rails 1680 may extend through holes in the fixture 1524 and may ensure that the section 1564 moves in directions parallel to the arrowed line B1.

The fourth screw 1568D is configured to engage the fourth bracket 1570D, and fourth bracket 1570D may be configured to hold fibers 1526A, 1526B in place when the fourth screw 1568D engages the fourth bracket 1570D. Thus, when the end screw 1572 is rotated, this causes the position of the section 1564 to be adjusted, thereby adjusting a tension in the fibers 1526A, 1526B. The end screw 1572 beneficially allows the tension level in fibers 1526A, 1526B to be maintained with high accuracy and precision. A torque wrench or another tool may be used to cause an appropriate amount of torque to be applied to the end screw 1572 in some embodiments.

Spacers 1574 may be positioned in the internal recess 1566 at one or more locations, and these spacers 1574 may provide an elastic force to urge the section 1564 away from the section 1562, with the elastic force opposing any force generated by tightening the end screw 1572. The spacers 1574 may be provided in the form of o-rings in some embodiments, and the spacers 1574 may comprise rubber or other materials.

The system 1522 includes various screws and brackets positioned at different locations. A first screw 1568A, a second screw 1568B, a third screw 1568C, and a fourth screw 1568D are provided, and a first bracket 1570A, a second bracket 1570B, a third bracket 1570C, and a fourth bracket 1570D are also provided. The first screw 1568A is configured to engage the first bracket 1570A, and the first bracket 1570A may be configured to hold fibers 1526A, 1526B in place when the first screw 1568A engages the first bracket 1570A.

The second screw 1568B is configured to engage the second bracket 1570B, and the second bracket 1570B may be configured to retain the primary tubes 1510A, 1510B in their appropriate position when the second screw 1568B engages the second bracket 1570B. As shown in FIG. 15B, the section 1562 includes grooves 1582 therein, and these grooves 1582 may be v-grooves, but other grooves may also be used. A respective primary tube 1510A, 1510B may be received in each of the grooves 1582, and the second bracket 1570B and/or the second screw 1568B may be configured to engage the primary tubes 1510A, 1510B. For example, the second bracket 1570B and/or the second screw 1568B may come in contact with the primary tubes 1510A, 1510B in a manner similar to the contact pins 246A, 246B of FIG. 10B. Upon engagement, the primary tubes 1510A, 1510B may be retained in position. In some embodiments, suction force or some other force may be applied to the primary tubes 1510A, 1510B so that the tubes 1510A, 1510B are positioned appropriately in the grooves 1595B, but no suction force is used in other embodiments.

The third screw 1568C is configured to engage the third bracket 1570C, and the third bracket 1570C may be configured to assist in restricting movement of secondary tubes and/or the fibers.

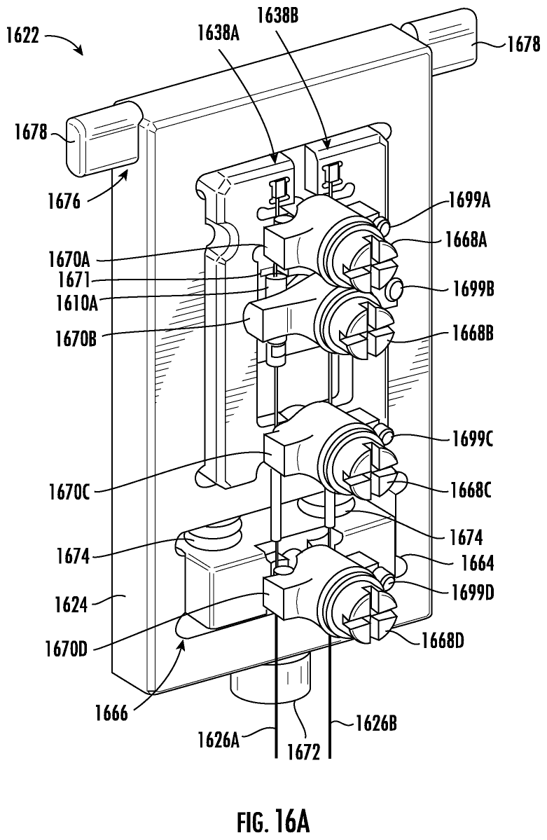

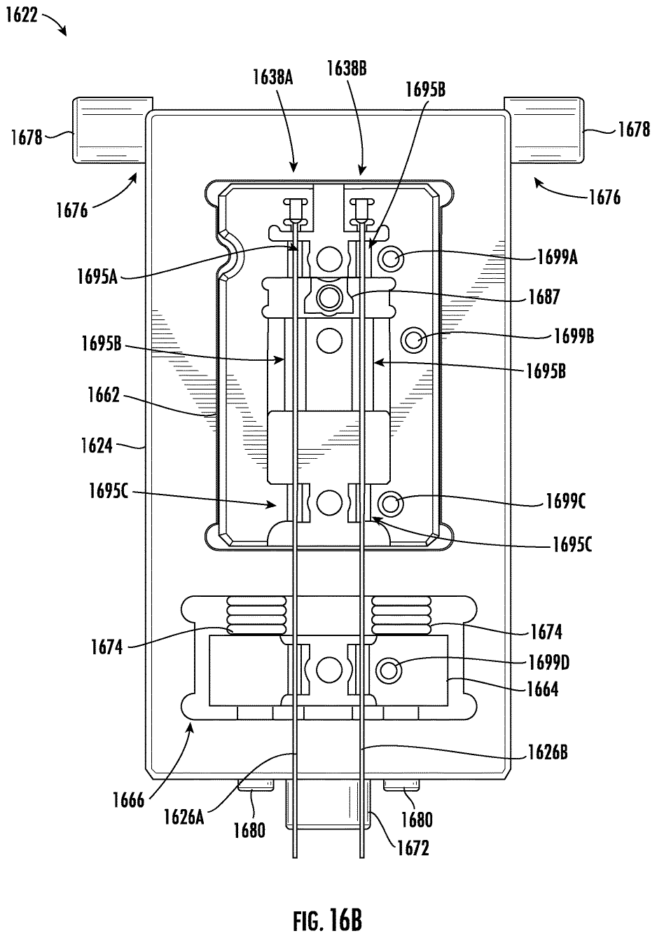

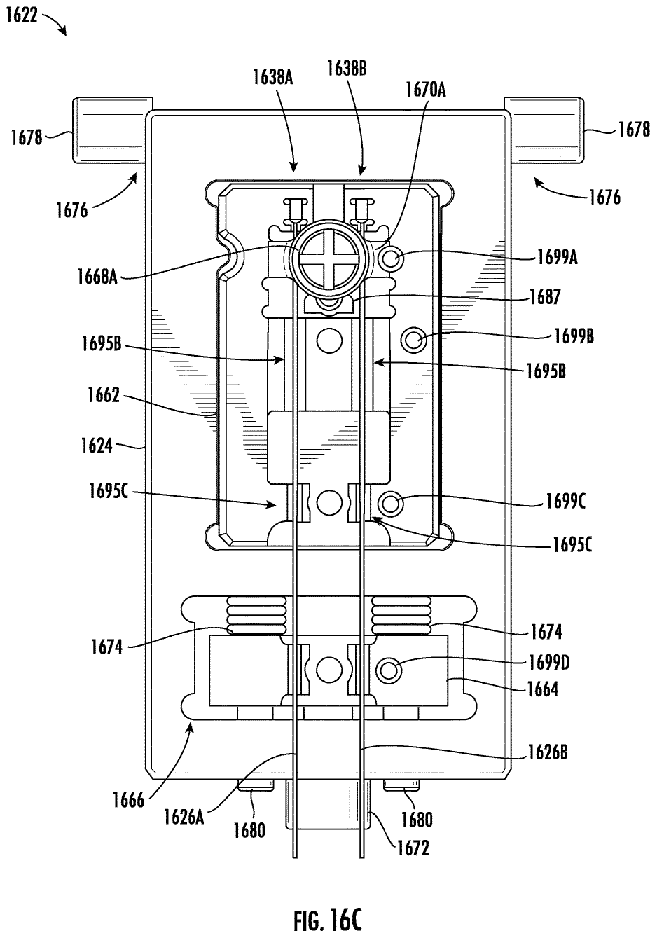

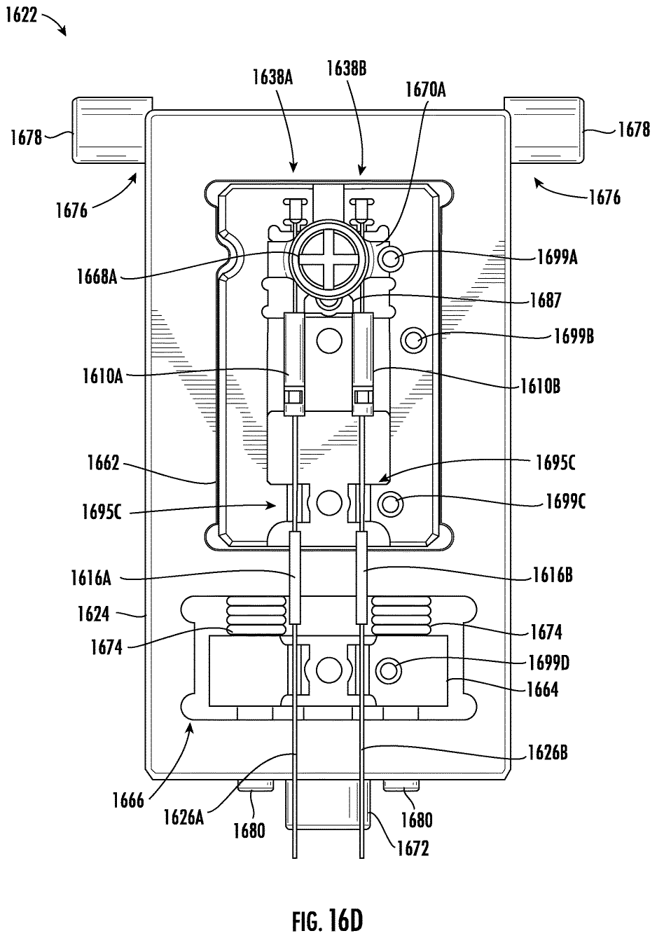

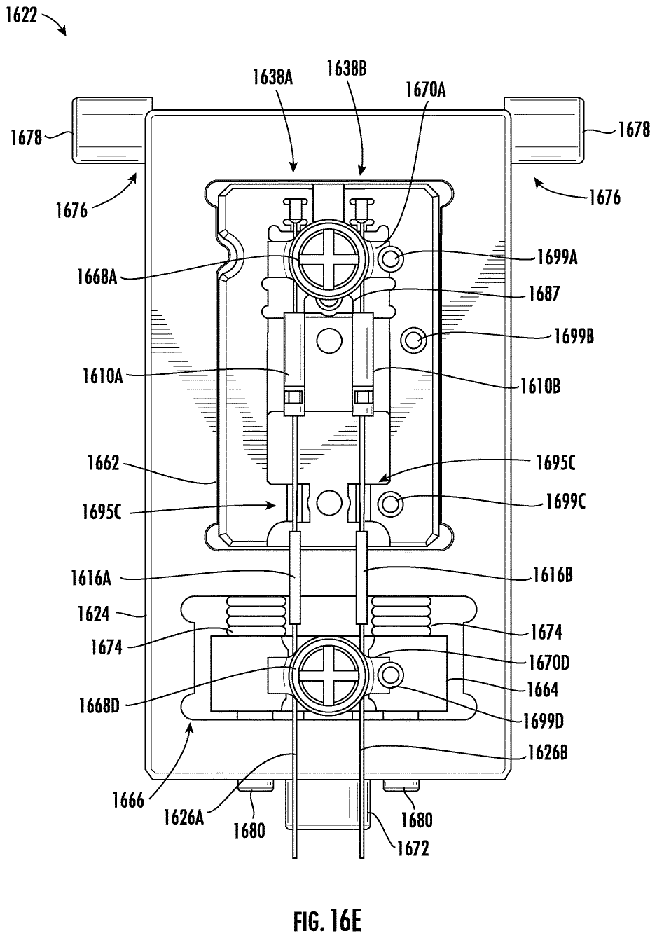

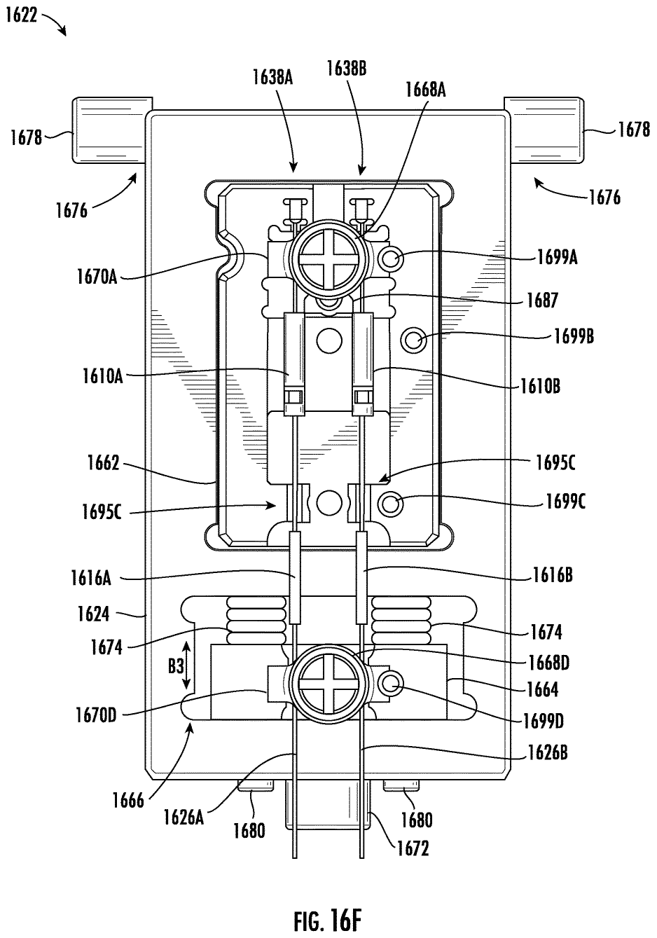

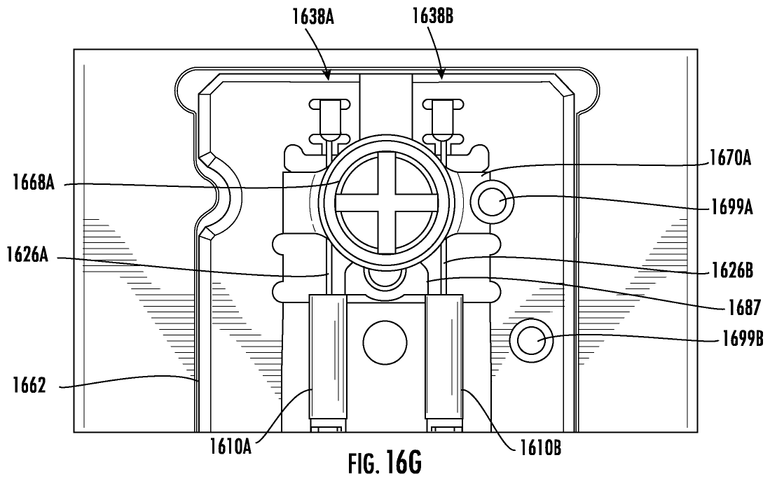

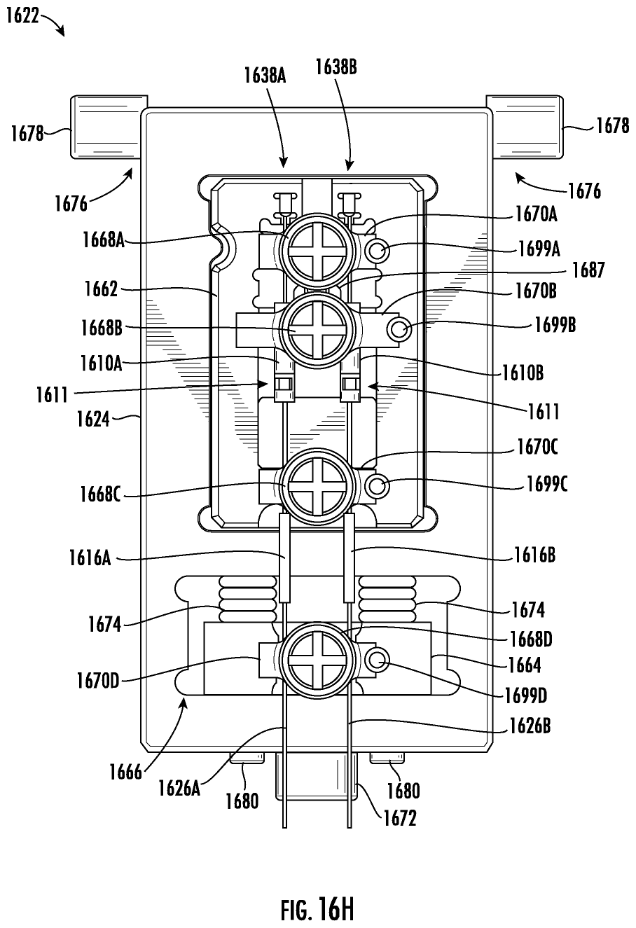

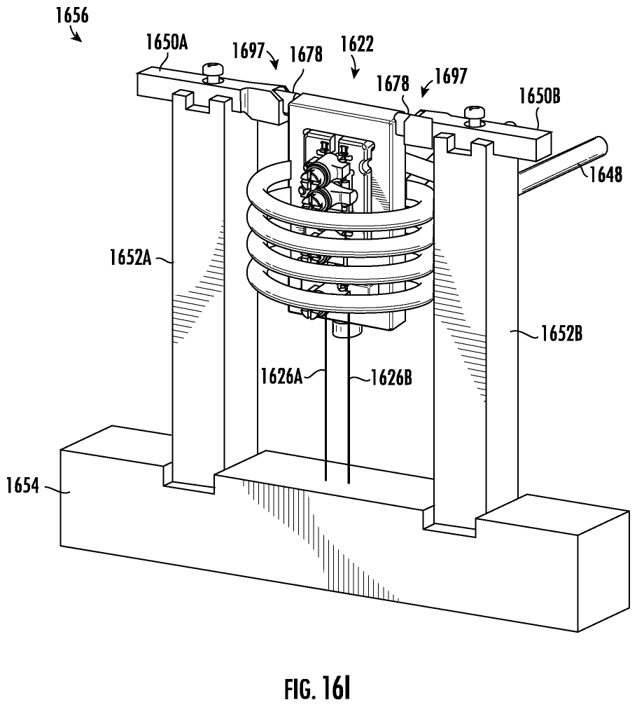

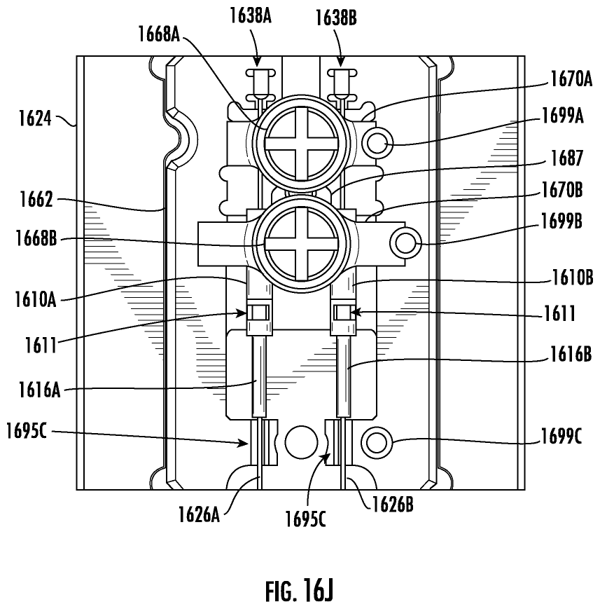

The fixture 1524 also defines slots 1576 on the side opposite the end screw 1572. The slots 1576 may be configured to receive arms 1578 therein, and these arms 1578 may be configured to assist in positioning the system 1522 relative to other devices. For example, the arms 1578 may be used to position the fixture in a heating coil assembly similar to the heating coil assembly of FIG. 16I.

Secondary tubes 1516A, 1516B are also illustrated in FIG. 15D. These secondary tubes 1516A, 1516B may be moved into the internal volumes defined within the primary tubes 1510A, 1510B. Glass blocks are also illustrated as being received within sinks 1538A, 1538B. Additionally, the end hole 1584 that the end screw 1572 may be received in is also illustrated in FIG. 15D.

Another example system 1622 for formation of a fiber assembly is illustrated in the perspective view of FIG. 16A, with this view illustrating where various brackets are positioned in the system 1622.

The system 1622 may allow the level of tension and the level of straightness in fibers to be effectively maintained by providing an adjustable section 1664, and this tension and straightness may allow the fiber assemblies to be improved by making the fiber assemblies stronger and more effective. The system 1622 may be capable of being adjusted to make products in having different specifications. For example, different inserts may be adjusted to change the fiber length of fibers, to adjust the position of primary tubes, or to adjust other properties of fiber assemblies that are created. Also, the system 1622 may have improved performance during the glass soldering process as the contact area between the primary tubes and the grooves that they contact may be reduced where V-grooves are used, thereby reducing heat loss that may occur during glass soldering. There is also an open area in the system 1622 that allows the temperature to be measured proximate to the primary tubes. For example, a temperature sensor 1671 may be positioned at an end of a primary tube as illustrated in FIG. 16A, with the temperature sensor 1671 positioned between the first bracket 1670A and the second bracket 1670B. Epoxy injection and epoxy curing may be performed without removing glass blocks, primary tubes, or secondary tubes, and brackets may restrain components so that epoxy injection and curing may be performed without negatively impacting glass blocks, primary tubes, or secondary tubes.

The system 1622 and the systems 1522, 1822 may allow fiber assemblies to be made with precision and accuracy, and the system 1622 may ensure that the fiber assemblies have a high quality in terms of centricity. This may be accomplished due to appropriately maintaining fiber tension, heating temperature, and heating times during fabrication of fiber assemblies. Centricity of fibers in the front side and back side of primary tubes may be controlled at levels of about 75 micrometers or less. Centricity may be measured by measuring the offset in relative positions for the fibers at the front side and back side of the primary tubes. For example, where a fiber is offset above the center of a primary tube by about 25 micrometers with no horizontal offset at a front side and where the fiber is offset below the center of the primary tube by about 25 micrometers with no horizontal offset at the rear side, then the centricity may be about 50 micrometers.

The system 1622 comprises a fixture 1624, and the system 1622 comprises a section 1662 and a section 1664. The section 1662 and/or the section 1664 may comprise plastic material or ceramic material in some embodiments, but one or more of these sections may comprise different materials in other embodiments. In some embodiments, the section 1662, the section 1664 and/or other portions of the fixture 1624 may comprise materials with a high temperature resistance, and these materials may include non-induction materials such as glass, engineering plastics (e.g., polyimide (PI), polyetherimide (PEI), polyetheretherketone (PEEK), etc.), ceramics, etc. Where ceramic material is used, this may enable the sections 1662, 1664 to hold up over time even through use in harsh conditions. By contrast, where other materials are used, the materials may tend to show changes in color over time, which may be indicative of degradation in the material, and this degradation may lead to possible failure of the fixtures. Grooves such as V-grooves may be machined in ceramic materials.

The fixture 1624 also defines an internal recess 1666, and section 1664 is received within the internal recess 1666. The section 1662 generally remains fixed in place relative to the surrounding portions of the fixture 1624. However, the section 1664 may be allowed to move relative to surrounding portions of the fixture 1624 as indicated by the arrowed line B3 in FIG. 16F. The fixture 1624 defines an end hole (not visible), and this end hole may be similar to the end hole 1584 shown in FIG. 15D. The end hole may be configured to receive an end screw 1672 so that the end screw 1672 may extend to the section 1664 and engage the section 1664. As a result of this engagement, a user may rotate the end screw 1672 to adjust the position of the section 1664 relative to the remainder of the fixture 1624. Guide rails 1680 are also provided. These guide rails 1680 may extend through holes in the fixture 1624 and may ensure that the section 1664 moves in directions parallel to the arrowed line B3 as illustrated in FIG. 16F. Movement of section 1664 may allow tension and straightness of fibers to be effectively maintained.

The fourth screw 1668D is configured to engage the fourth bracket 1670D, and fourth bracket 1670D may be configured to hold fibers 1626A, 1626B in place when the fourth screw 1668D engages the fourth bracket 1670D. Thus, when the end screw 1672 is rotated, this causes the position of the section 1664 and the fourth bracket 1670D to be adjusted, thereby adjusting a tension in the fibers 1626A, 1626B.

Spacers 1674 may be positioned in the internal recess 1666 at one or more locations, and these spacers 1674 may assist in retaining the section 1664 at a consistent position when the screw 1672 is not actively being used. The spacers 1674 may be provided in the form of o-rings in some embodiments, and the spacers 1674 may comprise rubber or other materials.

In addition to the fourth screw 1668D and the fourth bracket 1670D, the system 1622 also includes other screws and brackets positioned at different locations. A first screw 1668A, a second screw 1668B, and a third screw 1668C are provided, and a first bracket 1670A, a second bracket 1670B, and a third bracket 1670C are also provided. The first screw 1668A is configured to engage the first bracket 1670A, and the first bracket 1670A may be configured to hold fibers 1626A, 1626B in place when the first screw 1668A engages the first bracket 1670A. The first bracket 1670A may be positioned proximate to the glass blocks and sinks 1638A, 1638B.

The second screw 1668B is configured to engage the second bracket 1670B, and the second bracket 1670B may be configured to retaining the primary tubes 1610A, 1610B in their appropriate position when the second screw 1668B engages the second bracket 1670B. The section 1662 includes grooves 1695B therein, and these grooves 1695B may be v-grooves, but other grooves may also be used. A respective primary tube 1610A, 1610B may be received in each of the grooves 1695B, and the second bracket 1670B and/or the second screw 1668B may be configured to engage the primary tubes 1610A, 1610B. For example, the second bracket 1670B and/or the second screw 1668B may come in contact with the primary tubes 1610A, 1610B in a manner similar to the contact pins 246A, 246B of FIG. 10B. Upon engagement, the primary tubes 1610A, 1610B may be retained in position. In some embodiments, suction force or some other force may be applied to the primary tubes 1610A, 1610B so that the tubes 1610A, 1610B are positioned appropriately in the grooves 1695B. However, no suction force is applied in other embodiments.

The third screw 1668C is configured to engage the third bracket 1670C, and the third bracket 1670C may be configured to assist in separating the secondary tubes 1616A, 1616B from the primary tubes 1610A, 1610B until a certain stage in the manufacturing process. The screws 1668A-1668D, screws 1868A-1868D, and other similar screws described herein may comprise polyether ether ketone (PEEK) material in some embodiments rather than polyetherimide material (PEI). PEEK material is a high-performance thermoplastic polymer that is less likely to deform at high operating temperature than PEI material. Thus, by using PEEK material in screws, the screws may be less likely to deform.

The fixture 1624 also defines slots 1676 on the side opposite the end screw 1672. The slots 1676 may have arms 1678 attached therein, and these arms 1678 may be configured to assist in positioning the system 1622 relative to other devices. For example, the arms 1678 may be used to position the fixture 1624 in a heating coil assembly similar to the heating coil assembly 1656 of FIG. 16I.

Secondary tubes 1616A, 1616B are also illustrated in FIG. 16D. These secondary tubes 1616A, 1616B may be moved into the internal volumes defined within the primary tubes 1610A, 1610B. Glass blocks are also illustrated as being received within sinks 1638A, 1638B.

Guide rods 1699A-1699D may be received in holes within the sections 1662, 1664 so that the guide rods 1699A-1699D extend upwardly from the sections 1662, 1664. The guide rods 1699A-1699D may assist in positioning the brackets at specified locations along the length of the fibers 1626A, 1626B. For example, the guide rod 1699A may contact the first bracket 1670A, the guide rod 1699B may contact the second bracket 1670B, the guide rod 1699C may contact the third bracket 1670C, and the guide rod 1699D may contact the fourth bracket 1670D.

The materials used in the system 1622 and in other similar systems described herein may have a high temperature resistance and may comprise non-induction materials such as glass, engineered plastics, ceramics, and the like. However, other materials may be used.

FIG. 16A illustrates the system 1622 after all brackets 1670A-1670D have been attached. However, FIGS. 16B-16J show different features of the fixture at various stages as a fiber assembly is being formed.

FIG. 16B is a top view illustrating the system 1622 of FIG. 16A before brackets and other tubes are positioned in the system. In some embodiments, the fixture 1624 may be positioned on a relatively flat surface so that the face that is visible in FIG. 16B faces upwardly. The fibers 1626A, 1626B are provided, and the fibers 1626A, 1626B may be positioned relative to the fixture 1624 so that glass blocks are positioned in the sinks 1638A, 1638B. In the illustrated embodiment, two sinks and two fibers are used. However, a different number of sinks and fibers may be used in other embodiments.

Suction forces may optionally be applied at a variety of locations on the fixture 1624. For example, suction forces may be applied proximate to the sinks 1638A, 1638B, at a location proximate to each fiber 1626A, 1626B, and at a location proximate to the grooves 1695A-1695C. Once the fibers 1626A, 1626B are positioned appropriately, vacuum suction may be applied through small holes to help retain the fibers 1626A, 1626B or the glass blocks attached to the fibers 1626A, 1626B in the same position and/or orientation. Suction forces may also assist to move primary tubes and/or secondary tubes. However, vacuum suction may not be applied in some embodiments, and this may be beneficial to allow fiber assemblies to be created more quickly with reduced cycle times.

In FIG. 16B, other features of the system 1622 may be seen that are not visible in FIG. 16A. For example, grooves 1695A are formed in the section 1662 proximate to the guide rod 1699A. Grooves 1695B are formed in the section 1662 proximate to the guide rod 1699B, and grooves 1695C are formed in the section 1662 proximate to the guide rod 1699C. Grooves may also be positioned elsewhere (e.g., at the section 1664). When the fibers 1626A, 1626B are positioned relative to the fixture 1624, the fibers 1626A, 1626B may be positioned so that they are located proximate to respective grooves 1695A-1695C within the section 1662 and/or other grooves within the fixture 1624.

FIG. 16C illustrates the system 1622 after the first bracket 1670A and the first screw 1668A have been attached. The first bracket 1670A may be used to secure the fibers 1626A, 1626B in place at a location proximate to the glass blocks on the fibers 1626A, 1626B, with the first screw 1668A being used to secure the first bracket 1670A. The guide rod 1699A may be used to guide the first bracket 1670A and to ensure that the first bracket 1670A is positioned at the appropriate position. The fibers 1626A, 1626B may be adjusted so that an appropriate tension level is present in them when the first bracket 1670A is attached.

In FIG. 16D, the primary tubes 1610A, 1610B and the secondary tubes 1616A, 1616B are attached. These tubes are each hollow and define internal volumes. The primary tube 1610A and the secondary tube 1616A may have the fiber 1626A positioned within the internal volumes of the tubes 1610A, 1616A, and the tubes 1610A, 1616A may be adjusted in position relative to the fiber 1626A. The primary tube 1610B and the secondary tube 1616B may have the fiber 1626B positioned within the internal volumes of the tubes 1610B, 1616B, and the tubes 1610B, 1616B may be adjusted in position relative to the fiber 1626B. The primary tubes 1610A, 1610B may be similar to the primary tube 110 of FIG. 1A, and the primary tubes 1610A, 1610B may have glass preforms positioned therein that are similar to the glass preform 105. The primary tubes 1610A, 1610B may be adjusted in position so that they rest proximate to the grooves 1695B, and the secondary tubes 1616A, 1616B may be adjusted in position so that they are moved past the section 1664. The fibers 1626A, 1626B may generally be allowed to extend straight as the tubes 1610A, 1610B and the tubes 1616A, 1616B are repositioned and as brackets are attached. The methods generally described in reference to FIGS. 16A-16J and other methods described herein may minimize or eliminate the risk of a user inadvertently bending fibers, which may damage the fibers and reduce their effectiveness.

In FIG. 16E, the fourth screw 1668D and the fourth bracket 1670D are attached. The fourth bracket 1670D may be used to secure the fibers 1626A, 1626B in place, with the fourth screw 1668D being used to secure the fourth bracket 1670D. The guide rod 1699D may be used to guide the fourth bracket 1670D and to ensure that the fourth bracket 1670D is positioned appropriately. The fibers 1626A, 1626B may be adjusted so that an appropriate tension level is present in them when the fourth bracket 1670D is attached. By attaching the fourth bracket 1670D, the primary tubes 1610A, 1610B and the secondary tubes 1616A, 1616B may also be retained between the first bracket 1670A and the fourth bracket 1670D.

In FIG. 16F, the position of the section 1664 is adjusted relative to the remainder of the fixture 1624 as indicated by the arrowed line B3. The position of the section 1664 may be adjusted by rotating the end screw 1672 clockwise or counterclockwise. By adjusting the position of the section 1664, the tension level within the fibers 1626A, 1626B may be adjusted. For example, moving the section 1664 farther away from the section 1662 as illustrated in FIG. 16F may increase the tension level within the fibers 1626A, 1626B and may tend to straighten the fibers 1626A, 1626B further. Before adjustment of the position of the section 1664, the brackets 1670A, 1670D may be tightened relative to the fibers 1626A, 1626B to ensure that movement of the section 1664 appropriately adjusts the tension in the fibers 1626A, 1626B without slipping.

FIG. 16G illustrates an enhanced view of the system 1622 with the first bracket 1670A attached and with the primary tubes 1610A, 1610B moved to their appropriate positions. A suction force may be applied on the primary tubes 1610A, 1610B in some embodiments to cause the primary tubes 1610A, 1610B to be moved along the fibers 1626A, 1626B. The suction force may be applied until the primary tubes 1610A, 1610B come in contact with the bracket 1687, but other components may be used that may serve as a stop. While a suction force may be applied to cause the primary tubes 1610A, 1610B to be moved, the primary tubes 1610A, 1610B may be moved in other ways (e.g., by hand, by automated actuator, etc.).

FIG. 16H illustrates further brackets positioned in the system 1622. Once the primary tubes 1610A, 1610B are positioned appropriately, the primary tubes 1610A, 1610B may be retained in place through the use of the second bracket 1670B. The second screw 1668B may be used to facilitate attachment of the second bracket 1670B, and the guide rod 1699B may be used to help position the second bracket 1670B appropriately. Before the second bracket 1670B is tightened, the primary tubes 1610A, 1610B may be rotated so that any windows 1611 therein face upwardly. This may allow epoxy or another similar material to be easily dispensed in the windows 1611. The third bracket 1670C may also be attached as illustrated in FIG. 16H. The third bracket 1670C may be attached using the third screw 1668C, and the guide rod 1699C may be used to help position the third bracket 1670C appropriately. Attachment of the third bracket 1670C may retain the secondary tubes 1616A, 1616B between the third bracket 1670C and the fourth bracket 1670D and may prevent the secondary tubes 1616A, 1616B from being moved past the third bracket 1670C towards the primary tubes 1610A, 1610B.

The system 1622 may then be heated through glass soldering. FIG. 16I is a perspective view illustrating the system 1622 of FIG. 16H positioned within the loops of a heating coil 1648. The system 1622 may be attached to the heating coil assembly 1656 using the arms 1678. The arms 1678 may be received in the receptacles 1697 of the top members 1650A, 1650B of the heating coil assembly 1656, and the system 1622 may be allowed to hang. The top members 1650A, 1650B may be attached to the towers 1652A, 1652B of the heating coil assembly 1656, and the towers 1652A, 1652B may be attached to the base 1654 of the heating coil assembly 1656. The heating coil assembly 1656 may also include a heating coil 1648, and the heating coil 1648 may be an induction heating coil in some embodiments. The heat from the heating coil 1648 may heat the primary tubes 1610A, 1610B, which may comprise metal material. This heating coil 1648 wraps around in four loops, and the system 1622 may be positioned in the volume within these four loops so that the system 1622 and the components on the system 1622 may be heated. The heating coil assembly 1656 may be used to thermally cure the system 1622 and other components on the system 1622 such as the primary tubes 1610A, 1610B and the fibers 1626A, 1626B. Thermal curing may be performed in a manner similar to the thermal curing approaches described herein. Temperature sensors such as the temperature sensor 1671 of FIG. 16A may be used to monitor the temperature at a location on the primary tubes 1610A, 1610B. The heating temperature used during glass soldering may impact the performance of the resulting fiber assemblies that are manufactured. Consequently, effectively monitoring and controlling the heating temperature throughout glass soldering is beneficial to optimize the performance of the resulting fiber assemblies.

After heating using the heating coil assembly 1656, the system 1622 may be removed from the heating coil assembly 1656. Furthermore, epoxy may be injected into the primary tubes 1610A, 1610B (e.g., at the internal portions of the tubes proximate to where the tubes each contact the bracket 1687). While doing so, the fixture 1624 may be held in one hand while the epoxy is dispensed manually using another hand. However, in other embodiments, the epoxy may be dispensed in an automated manner. After epoxy has been injected into the primary tubes 1610A, 1610B, the system 1622 may undergo ultraviolet curing.

The secondary tubes 1616A, 1616B may then be shifted into the primary tubes 1610A, 1610B, and FIG. 16J illustrates an example of this. The third bracket 1670C may be removed so that the secondary tubes 1616A, 1616B may be shifted into the primary tubes 1610A, 1610B. The secondary tubes 1616A, 1616B may be moved until they reach a stop within the primary tubes 1610A, 1610B in some embodiments. Additionally, the fixture 1624 may be positioned on a relatively flat surface so that the visible surface in FIG. 16J faces upwardly.

Once the secondary tubes 1616A, 1616B are positioned appropriately relative to the primary tubes 1610A, 1610B, further epoxy or another similar material may be inserted into the windows 1611 so that each secondary tube is bonded to a respective primary tube. The system 1622 may then undergo ultraviolet curing and subsequent thermal curing (e.g., by placing the system 1622 in an oven to heat the system 1622).

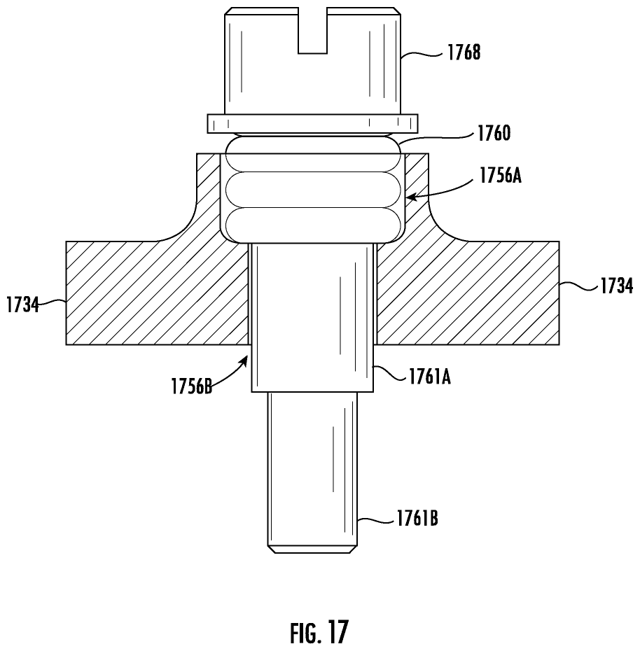

FIG. 17 is a schematic, cross-sectional view illustrating an example screw 1768 received within a bracket 1734. The bracket 1734 may generally be similar to the brackets 1634A-1634D described herein. The bracket 1734 defines openings 1756A, 1756B therein, with the opening 1756A being larger in width than the opening 1756B. The screw 1768 may be at least partially received in the bracket. In some embodiments, the opening 1756A or the opening 1756B may be threaded, and any threads may be configured to engage threads on the screw 1768 to enable the screw 1768 and the bracket 1734 to be attached together. Spacers 1760 are provided in the opening 1756A, and the spacers 1760 may be compressed as the screw 1768 is tightened. The amount of force applied by the spacers 1760 may vary depending on the distance that the screw 1768 is moved. The screw 1768 may define a portion 1761A and a portion 1761B, with the portion 1761A having a larger width than the portion 1761B. Spacers 1760 may tend to urge the screw 1768 outwardly when threads of the screw are not engaged.

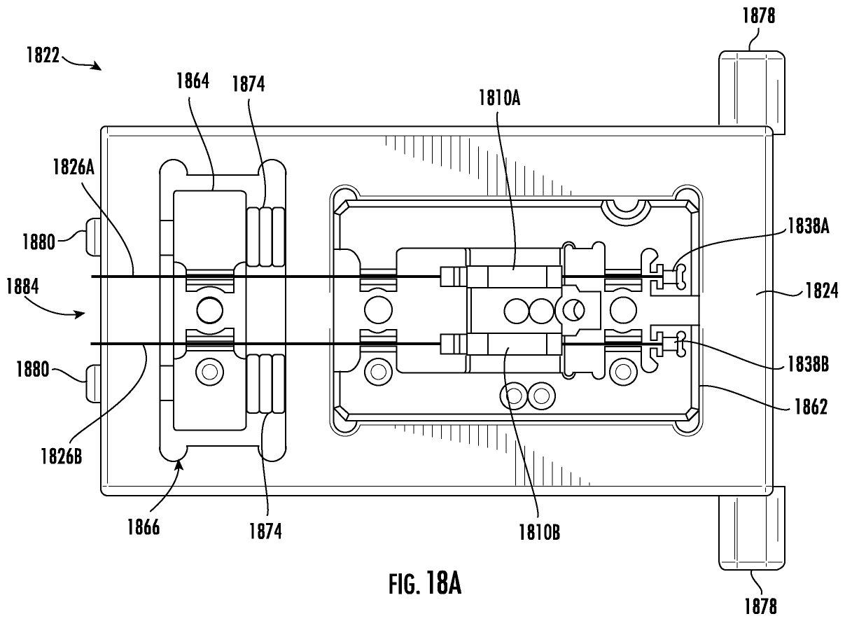

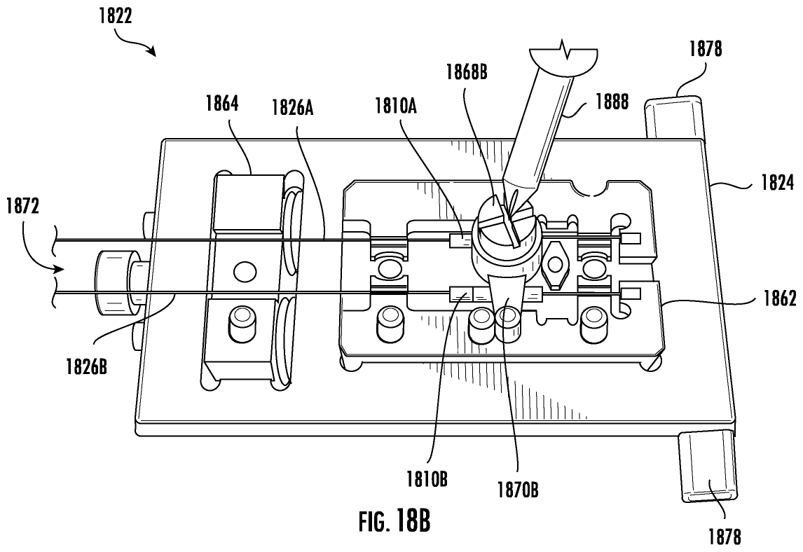

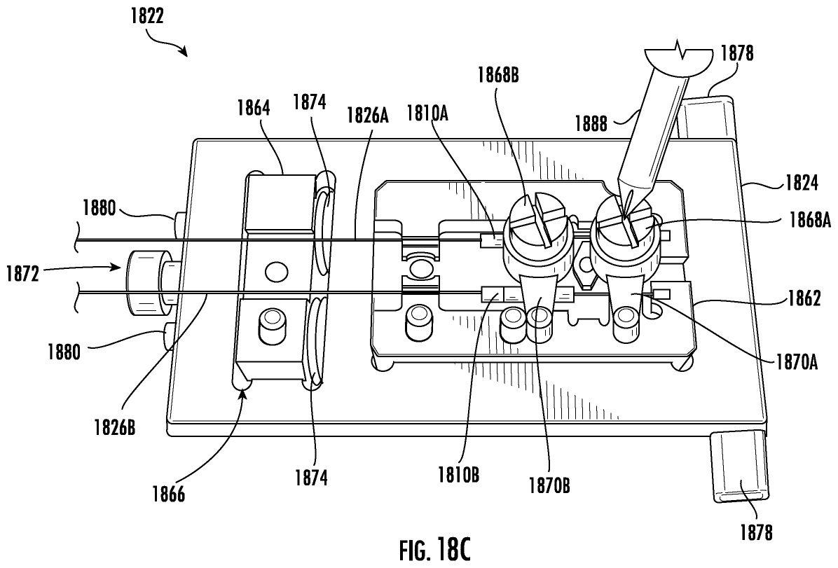

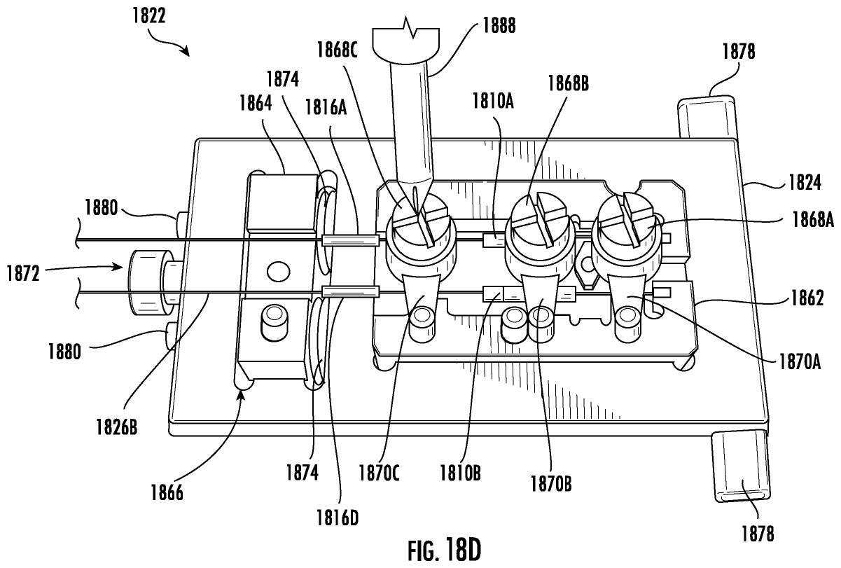

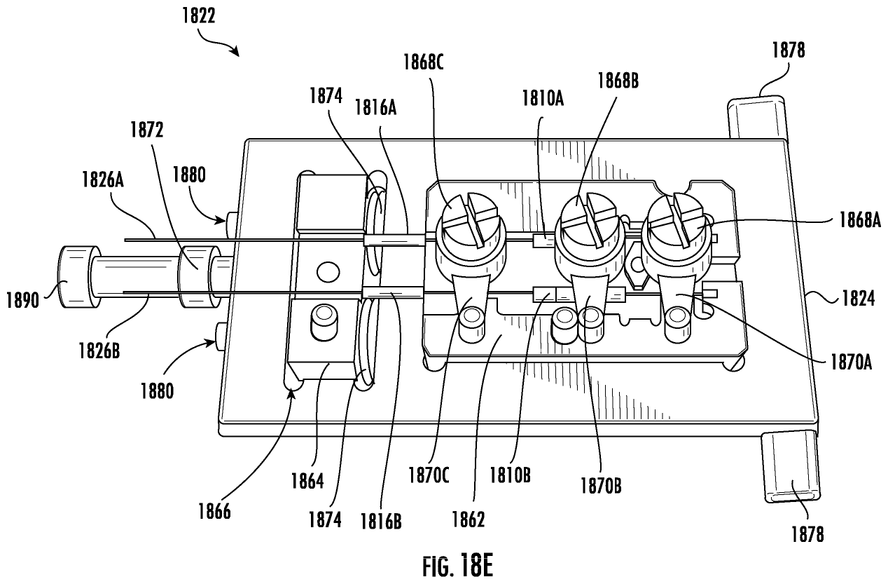

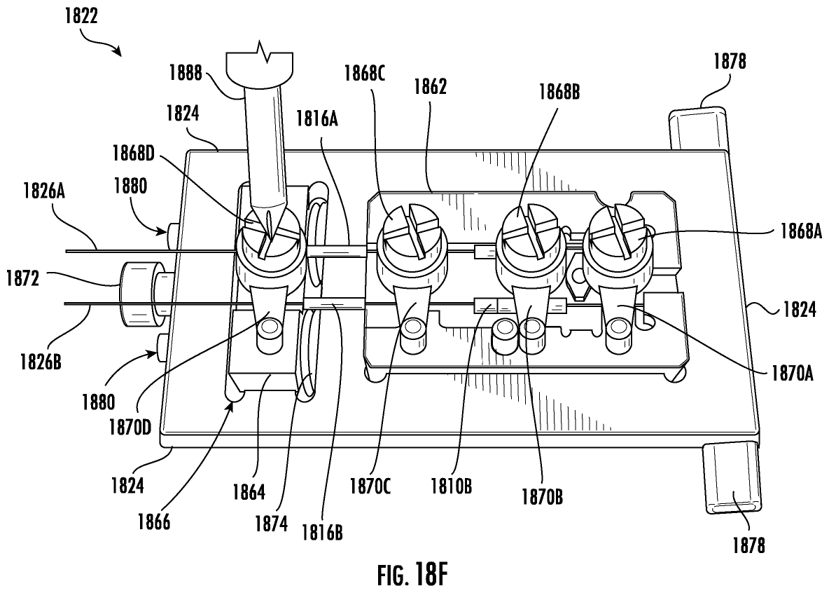

Another system 1822 for making fiber assemblies is illustrated in FIGS. 18A-18F, and a different approach may be taken with the system 1822 in order to make fiber assemblies. The system 1822 is generally similar to the system 1622. The system 1822 comprises a fixture 1824, and the system 1822 comprises a section 1862 and a section 1864. The fixture 1824 also defines an internal recess 1866, and section 1864 is received within the internal recess 1866. The section 1862 generally remains fixed in place relative to the surrounding portions of the fixture 1824. In some embodiments, the fixture 1824 and the sections thereof may comprise a ceramic material, but other materials may be used such as high temperature resistance materials, non-induction materials, glass, engineering plastics (e.g., polyimide (PI), polyetherimide (PEI), polyetheretherketone (PEEK), etc.), and the like.

As shown in FIGS. 18A-18F, the system 1822 comprises primary tubes 1810A, 1810B, secondary tubes 1816A, 1816B, fibers 1826A, 1826B, glass blocks that may be received in sinks 1838A, 1838B formed in the section 1862, spacers 1874, arms 1878, guide rails 1880, and an end hole 1884. Each of these components are identical to the components in the system 1622 unless noted otherwise.

While the systems 1622, 1822 are generally the same, the system 1822 is used differently in FIGS. 18A-18F to create a fiber assembly. Starting with FIG. 18A, the fixture 1824 is illustrated alongside the fibers 1826A, 1826B. The fibers 1826A, 1826B may first be positioned relative to the fixture 1824 so that glass blocks are received in the respective sinks 1838A, 1838B. Glass blocks may be received in the sinks 1838A, 1838B so that the glass blocks lie flat, and suction force may be generated at the sinks 1838A, 1838B in some embodiments to assist with positioning the glass blocks.

Additionally, the hollow primary tubes 1810A, 1810B are provided. These primary tubes 1810A, 1810B may each have a respective fiber 1826A, 1826B received therein and then the primary tubes 1810A, 1810B may be shifted along the fibers 1826A, 1826B to appropriate positions. The primary tubes 1810A, 1810B may be moved to a location proximate to grooves (not shown) that may be defined within the section 1862. These grooves may be similar to other grooves described herein. The fibers 1826A, 1826B may be window-stripped fibers in some embodiments. In some embodiments, suction forces may be generated to cause the primary tubes 1810A, 1810B to move to appropriate positions, and suction forces may optionally be used to position the fibers 1826A, 1826B appropriately. The suction forces may be generated using approaches described herein (e.g., through holes in the fixture 1824 or through other similar approaches). However, the position of primary tubes 1810A, 1810B and the fibers 1826A, 1826B may be manually adjusted in some embodiments, and manual adjustment may be performed after suction forces are applied in some embodiments to ensure appropriate positioning of components.

In FIG. 18B, the second bracket 1870B is being tightened relative to the primary tubes 1810A, 1810B. The second bracket 1870B may be tightened relative to the primary tubes 1810A, 1810B using the second screw 1868B. A tool 1888 may be used to tighten the second screw 1868B in some embodiments. The tool 1888 may be a torque wrench that is configured to apply a certain amount of torque while tightening the second screw 1868B. For example, a torque wrench may be used in some embodiments that is configured to apply up to about 0.5 kgf·cm of torque to tighten the screws. Torque wrenches may be used to tighten other screws as well, and different torque wrenches may be applied to adjust tightness to different levels as appropriate. A guide rod similar to guide rod 1699B may be provided to position the second bracket 1870B in the appropriate location along the length of the fibers 1826A, 1826B.

The glass blocks may have bevels at the end of the glass blocks. Before proceeding with assembly of the fiber assembly, the bevel direction may be checked using a microscope. If the bevel direction is not correct, the position and/or orientation of the glass blocks may be adjusted. The bevel direction may be confirmed after the second bracket 1870B is positioned in some embodiments, but the bevel direction may be confirmed at other stages during the fiber assembly process.

FIG. 18C illustrates the tool 1888 being used to tighten the first bracket 1870A relative to the fibers 1826A, 1826B so that the fibers 1826A, 1826B are generally retained in place. The first bracket 1870A may be tightened relative to the fibers 1826A, 1826B using the first screw 1868A. A guide rod similar to guide rod 1699A may be provided to position the second bracket 1870B in the appropriate location along the length of the fibers 1826A, 1826B. The first bracket 1870A is positioned proximate to the glass blocks and sinks 1838A, 1838B.

At the stage illustrated in FIG. 18D, the third bracket 1870C is attached using a third screw 1868C, with the tool 1888 being used to tighten the third screw 1868C. A guide rod similar to guide rod 1699C may be provided to position the third bracket 1870C in the appropriate location along the length of the fibers 1826A, 1826B. The third bracket 1870C may be configured to confine the position of fibers 1826A, 1826B until the fourth bracket 1870D is attached.

The hollow secondary tubes 1816A, 1816B are also introduced in FIG. 18D, but these may be introduced at a different stage in other embodiments. These secondary tubes 1816A, 1816B may each have a respective fiber 1826A, 1826B received therein and then the secondary tubes 1816A, 1816B may be shifted along the fibers 1826A, 1826B to appropriate positions so that they will be positioned between brackets 1870C, 1870D. The secondary tubes 1816A, 1816B may be moved to a location past the section 1864. However, the third bracket 1870C may prevent the secondary tubes 1816A, 1816B from moving further towards the primary tubes 1810A, 1810B until the third bracket 1870C is removed.

FIG. 18E is a top perspective view illustrating the system of FIG. 18D with another tool 1890 being used to adjust a position of the section 1864. The tool 1890 may be a torque wrench similar to the tool 1888, and the tool 1890 may be configured to provide the same or a different level of torque relative to the tool 1888. The tool 1890 may be a torque wrench configured to apply up to about 0.05 kgf·cm of torque in some embodiments, but different torque wrenches or other tools may be used instead. As the tool 1890 rotates the end screw 1872, the end screw 1872 may cause the section 1864 to move. Spacers 1874 may be provided in the internal recess 1866 that may compress against the section 1864 at different levels depending on the rotational position of the end screw 1872. While the tool 1890 is illustrated as being used before the fourth bracket 1870D is attached, the tool 1890 or another tool may be used in a similar manner after the fourth bracket 1870D has been attached in some embodiments.

FIG. 18F is a top perspective view illustrating the system of FIG. 18F with a tool 1888 being used to generally secure another bracket relative to the fibers. The fourth bracket 1870D may be tightened relative to the fibers 1826A, 1826B using the fourth screw 1868D. A guide rod similar to guide rod 1699D may be provided to position the fourth bracket 1870D in the appropriate location along the length of the fibers 1826A, 1826B.

After the fourth bracket 1870D is attached, the end screw 1872 may be adjusted further to adjust the position of the section 1864 and the tension within the fibers 1826A, 1826B. For example, the end screw 1872 may be removed from the fixture 1824, and doing so may adjust the position of the section 1864, thereby leading to increased tension in the fibers 1826A, 1826B. By using the end screw 1872 and a tool 1890 such as a torque wrench, the level of tension in the fibers 1826A, 1826B may be effectively adjusted with a high degree of accuracy and precision. The tool 1890 may be used to adjust the section 1864 to an appropriate position before the fourth bracket 1870D is attached and before the end screw 1872 is removed, the fourth bracket 1870D may be used to restrict movement of the fibers 1826A, 1826B relative to the section 1864, and then the position of the section 1864 and tension within the fibers 1826A, 1826B may be adjusted with precision and accuracy by removing the end screw 1872. The desired tension may be obtained in the fibers 1826A, 1826B by controlling the initial position of the section 1864 before the end screw 1872 is removed and by controlling the final position of the section 1864 after the end screw 1872 is removed.

The end screw 1872 and other end screws described herein may comprise metal in some embodiments, but other materials may be used in end screws. The assembled system 1822 may be subjected to glass soldering as described herein. Further, epoxy may be introduced and cured as described in other embodiments in the system, and system 1822 may also be heated by baking the system 1822 in some embodiments.

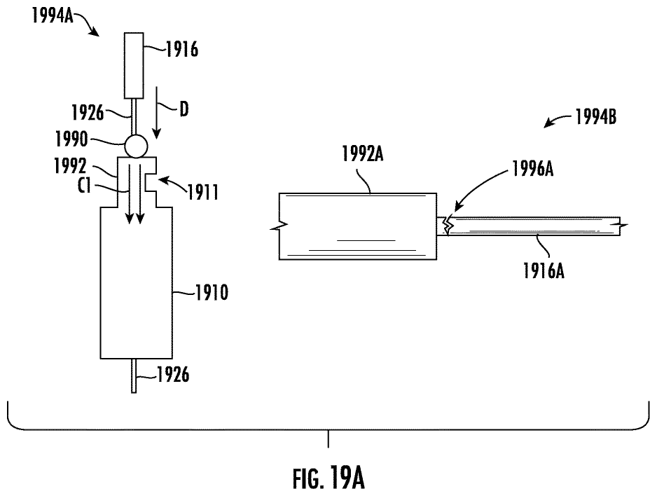

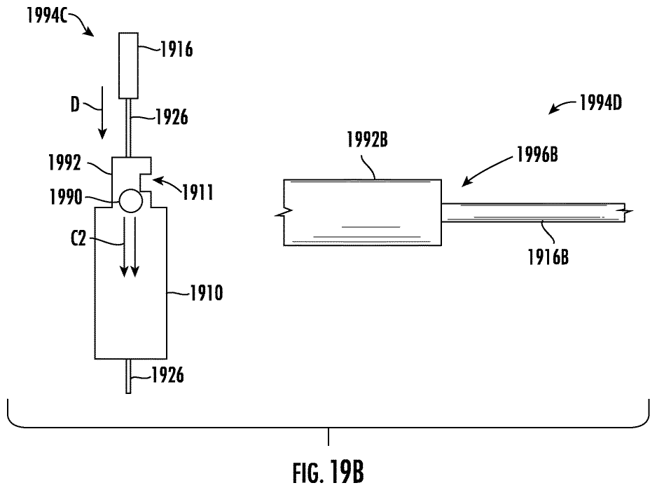

As noted herein, epoxy may be introduced to assist in attaching a primary tube and a secondary tube together. Two different approaches for this are illustrated in FIGS. 19A and 19B, with these figures also illustrating how cracks may form under one approach.

FIG. 19A illustrates a first assembly 1994A being formed using a first approach, and FIG. 19A also illustrates a resulting crack formed in the final assembly 1994B formed using the first approach. A primary tube 1910 is provided in the first assembly 1994A, with the primary tube 1910 having a narrowed section 1992 and a window 1911 therein. The primary tube 1910 may be similar to other primary tubes described herein, and the primary tube 1910 is hollow so that it may receive a fiber 1926 therein. Similarly, the secondary tube 1916 is provided in the first assembly 1994A, with the secondary tube 1916 being hollow so that the fiber 1926 is received in the secondary tube 1916.

With the first approach illustrated in FIG. 19A, the primary tube 1910, the secondary tube 1916, and the fiber 1926 may be oriented so that they are each upright as illustrated in FIG. 19A. Epoxy 1990 may then be introduced above the narrowed section 1992 of the primary tube 1910, and this epoxy 1990 may be allowed to move downwardly within the narrowed section 1992 as indicated by the arrows C1. Once epoxy 1990 has been dispensed, the secondary tube 1916 may be moved into the narrowed section 1992 as indicated by the arrow D.

After the final assembly is completed and the fiber assemblies are used, cracks may form in the epoxy that binds the primary tube and the secondary tube together as illustrated in the final assembly 1994B of FIG. 19A. The narrowed section 1992A of a primary tube is illustrated on the left in the final assembly 1994B, and the secondary tube 1916A is illustrated on the right. Cracks may form at the area 1996A within the epoxy because an excessive amount of epoxy is provided, resulting in an overflow of epoxy. With excessive epoxy, cracks may form due to the high hardness of the epoxy. This may be detrimental because cracks in the epoxy may lead to unwanted movement of the primary and secondary tubes relative to each other, and fiber assemblies could eventually fail or have a diminished performance as a result.

FIG. 19B illustrates a second assembly 1994C being formed using a second approach, and FIG. 19B also illustrates a final assembly 1994D formed using the second approach that does not include any cracks in the epoxy. The second assembly 1994C includes the same components as the first assembly 1994A illustrated in FIG. 19A, but the epoxy 1990 is introduced at the window 1911 rather than being dispensed above the narrowed section 1992 of the primary tube 1910. In some embodiments, the tool being used to dispense epoxy may be inserted through the window 1911 so that epoxy may be dispensed below the window 1911. Once introduced at the window 1911, the epoxy 1990 may move downwardly as illustrated by the arrows C2.

After the final assembly is completed and the fiber assemblies are used, cracks are less likely to form using the second approach. The final assembly 1994D is illustrated with the narrowed section 1992B of a primary tube on the left and with the secondary tube 1916B on the right. Cracks generally do not form at the area 1996B proximate to the edge of the narrowed section 1992A. This is because there is less epoxy, and the hardness of the epoxy is lower than the epoxy in the final assembly 1994B of FIG. 19A. This may be beneficial to maintain strength and optimal performance of fiber assemblies that are formed.

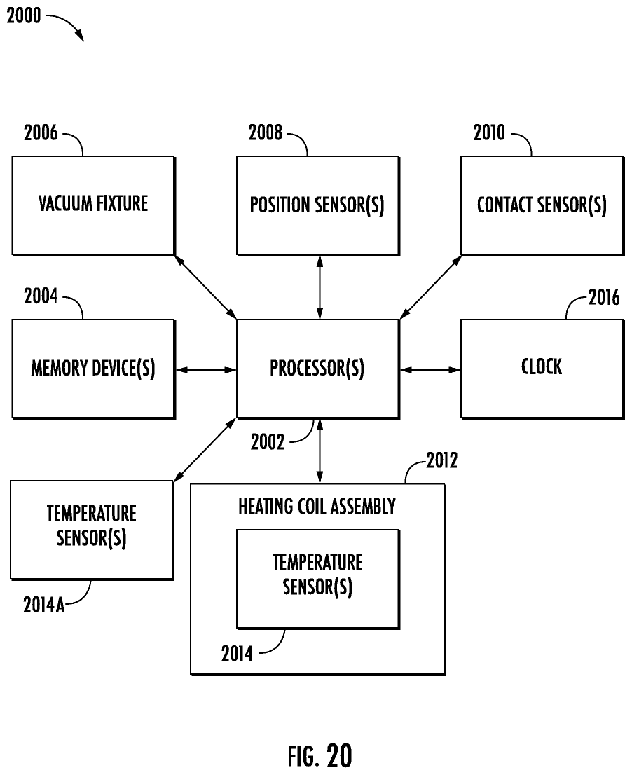

Turning ahead to FIG. 20, a block diagram is shown illustrating various components of an example system 2000 for formation of a fiber assembly. The system 2000 includes one or more processors 2002. The processor(s) 2002 may be any means configured to execute various programmed operations or instructions stored in a memory device (e.g., memory device(s) 2004) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor(s) 2002 as described herein. In this regard, the processor(s) 2002 may be configured to analyze electrical signals communicated thereto to control temperature applied by the heating coil assembly 2012, to maintain a temperature profile, to facilitate movement of components using vacuum suction from the vacuum fixture 2006, and the like. However, the processor(s) 2002 may also execute other functions.

The system 2000 also includes one or more memory devices 2004. In an example embodiment, the memory device(s) 2004 may include one or more non-transitory storage or memory devices such as, for example, volatile and/or non-volatile memory that may be either fixed or removable. The memory device(s) 2004 may be configured to store instructions, computer program code and other data such as position data, temperature data, time data, etc. in a non-transitory computer readable medium for use, such as by the processor(s) 2002 for enabling the system 2000 to carry out various functions in accordance with example embodiments contemplated herein. For example, the memory device(s) 2004 could be configured to buffer input data for processing by the processor(s) 2002. Additionally, or alternatively, the memory device(s) 2004 could be configured to store instructions for execution by the processor(s) 2002.

Additionally, the system 2000 includes a vacuum fixture 2006, but additional vacuum fixtures may also be included in the system 2000. The vacuum fixture 2006 may enable vacuum suction to be used to control the position of one or more components within the system 2000. However, vacuum fixture 2000 may be omitted in some embodiments.

The system 2000 also includes one or more position sensor(s) 2008. The position sensor(s) 2008 may be beneficial to determine the position of components such as primary tubes 210A, 210B, secondary tubes 216A, 216B, the fixture 224, etc. The position data from position sensor(s) 2008 may be used by the processor to determine that components are improperly positioned and to determine that vacuum suction should be applied to move one or more of these components. Furthermore, the system 2000 includes one or more contact sensors 2010. Contact sensor(s) 2010 may be used in addition to or an alternative to position sensor(s) 2008. Contact sensor(s) 2010 may detect when certain components come in contact with the contact sensor(s) 2010, and the contact sensor(s) 2010 may therefore be used to confirm that the components are in an appropriate position. The system 2000 includes a heating coil assembly 2012, with the heating coil assembly 2012 including one or more temperature sensor(s) 2014. However, in some embodiments, one or more temperature sensors 2014 may be positioned at other locations such as on a fixture 224. The system 2000 also includes a clock 2016 to obtain time data. The processor(s) 2002 may utilize data from one or more of the position sensor(s) 2008, the contact sensor(s) 2010, the temperature sensor(s) 2014, and the clock 2016 in controlling operation of the system 2000. In some embodiments, the processor(s) 2002 may be configured to control the operation of the system 2000 in an automated or a semi-automated manner to reduce the need for human intervention in the manufacturing processes for fiber assemblies.

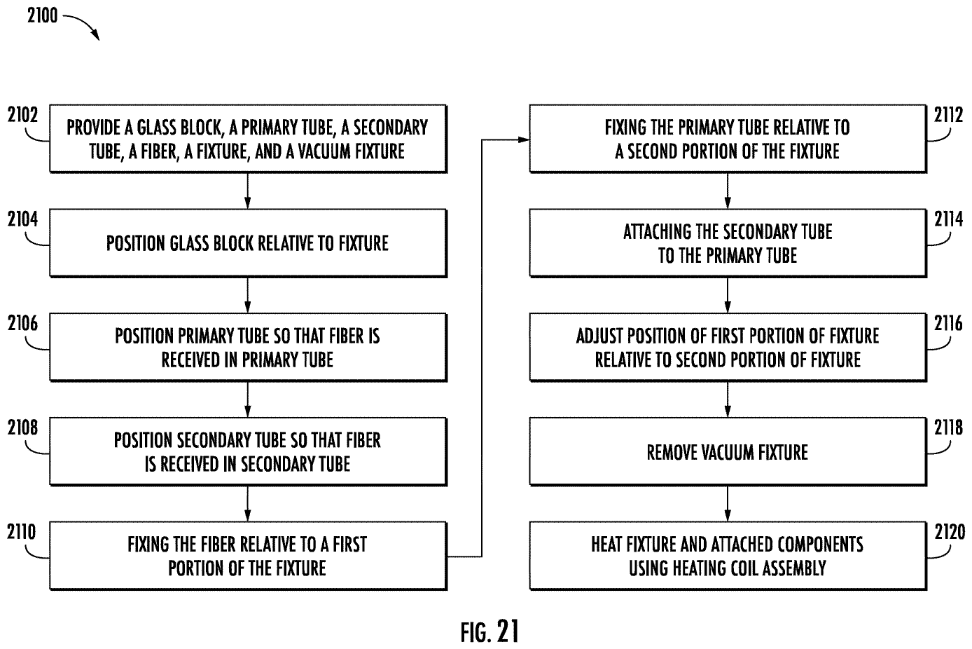

Methods for forming fiber assemblies are also contemplated, and FIG. 21 is a flow chart illustrating one example method 2100 for forming of a fiber assembly. At operation 2102 of method 2100, various components may be provided. These components include a glass block, a primary tube, a secondary tube, a fiber, a fixture, and a vacuum fixture. The primary tube and the secondary tube each define a cavity therein, and the primary tube and secondary tube may be configured to receive the fiber within these cavities. The fixture may comprise a first portion and a second portion that is configured to move relative to the first portion. The fixture may also comprise a sink within the fixture.

At operation 2104, a glass block may be positioned relative to the fixture. The glass block may be positioned at the sink within the fixture, and the glass block may eventually be attached to the fiber. Vacuum suction may be used to assist in maintaining positioning of the glass block at the fixture.

At operation 2106, the primary tube is positioned so that the fiber is received in the cavity of the primary tube. At operation 2108, the secondary tube is positioned so that the fiber is received in the cavity of the secondary tube. At operation 2110, the fiber may be fixed relative to a first portion of the fixture. Vacuum suction may be used to assist in maintaining positioning of the fiber in the appropriate position relative to the first portion of the fixture. The fiber may be fixed relative to the first portion through the use of one or more brackets. For example, in FIG. 2, brackets 232, 236 assist in fixing fibers relative to the first portion.

At operation 2112, the primary tube is fixed relative to a second portion of the fixture. Vacuum suction may be used to assist in maintaining positioning of the primary tube in the appropriate position relative to the second portion of the fixture. The primary tube may be fixed relative to the second portion through the use of a bracket. For example, in FIG. 2, bracket 234 assists in fixing primary tubes relative to the second portion. As discussed herein, contact pins 246A, 246B (see FIG. 10B) and screws 258A, 258B (see FIG. 10A) may also assist in fixing the primary tubes relative to the second portion.

At operation 2114, the secondary tube may be attached to the primary tube. Vacuum suction may be used to assist in maintaining positioning of the secondary tube in the appropriate position relative to the primary tube. Additionally, epoxy may be introduced to assist in facilitating the attachment of the primary tube to the secondary tube. Epoxy may be introduced at a window within the primary tube, at the end of the primary tube where an opening of the internal cavity therein is exposed, or at one or more alternative locations. Epoxy may be dispensed in the manner described in reference to FIG. 19B.

At operation 2116, the position of the first portion of the fixture may be adjusted relative to the position of the second portion of the fixture. By doing so, the primary tube may move relative to the fiber, and the length of the fiber extending from the primary tube may therefore be adjusted. The position of the first portion may be moved relative to the second portion through the use of positioning screws 242A, 242B as discussed herein.

At operation 2118, the vacuum fixture may be removed. At operation 2120, the fixture and other components that remain attached to the fixture may be heated using a heating coil assembly as described herein. In some embodiments, further epoxy may be added and cured through ultraviolet curing after heating with the heating coil assembly. Additionally, the fixture and other attached components may undergo further thermal curing (e.g., by placing the fixture within an oven). Thermal curing and/or ultraviolet curing may be performed on the fixture without removing brackets, fibers, primary tubes, or secondary tubes from the fixture.

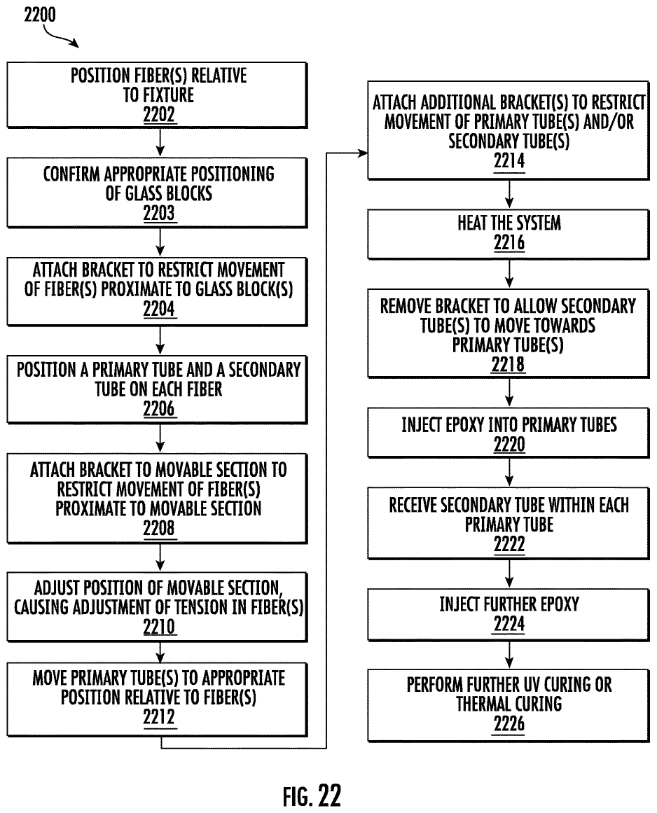

FIG. 22 illustrates another example method 2200 of forming a hermetic fiber feedthrough assembly. This method 2200 may generally correspond to the approach used in FIGS. 16A-16J.

At operation 2202, one or more fibers may be positioned relative to a fixture. Fibers may be positioned so that glass blocks attached on the fibers are positioned in sinks within the fixture. Additionally, fibers may be positioned so that they generally extend straight without excessive bending at any point along the length of the fibers. Fibers may be positioned so that they are received in grooves formed within the fixture. Fibers and glass blocks may be positioned as shown in FIG. 16B.

At operation 2203, the appropriate positioning of any glass blocks on the fibers may be evaluated and confirmed. Additionally, the appropriate positioning of the fibers that the glass blocks are attached to may be confirmed. Microscopes may be used to evaluate the positioning of the glass blocks and/or the fibers at operation 2203. However, appropriate positioning may be confirmed through a visual inspection without the use of a microscope in some embodiments, or appropriate positioning may be confirmed in other ways.

At operation 2204, a bracket may be attached to restrict movement of any fibers at a location proximate to the glass block(s). This bracket may correspond to the first bracket 1670A introduced in FIG. 16C. A screw (e.g., first screw 1668A) may be used to secure the bracket, and a guide rod (e.g., guide rod 1699A) may be used to guide the bracket and to ensure that the bracket is positioned at the appropriate position. The fibers may be adjusted so that an appropriate tension level is present in them when the bracket is attached.

At operation 2206, a primary tube and a secondary tube may be positioned on each fiber. An example of this is illustrated in FIG. 16D. These tubes are each hollow and define internal volumes. Primary tubes may be adjusted in position on the fibers so that they rest proximate to grooves in the fixture, and the secondary tubes may be adjusted in position relative to fibers so that they are moved past a movable section of the fixture. The fibers may generally be allowed to extend straight as the primary and secondary tubes are repositioned.

At operation 2208, a bracket may be attached to a movable section to restrict movement of any fibers proximate to the movable section. This bracket may be similar to the fourth bracket 1670D introduced at FIG. 16E. A screw (e.g., fourth screw 1668D) may be used to secure the bracket. The bracket may be used to secure the fibers in place. A guide rod (e.g., guide rod 1699D) may be used to guide the bracket and to ensure that the bracket is positioned appropriately. The fibers may be adjusted so that an appropriate tension level is present in them when the fourth bracket is attached. By attaching the bracket, the primary tubes and the secondary tubes may also be retained between the attached brackets introduced at operations 2204 and 2208.

At operation 2210, a position of the movable section may be adjusted, and this may result in adjustment of the tension within any fibers. An example of this is illustrated in FIG. 16F. An end screw (e.g., end screw 1672) may be rotated, and this rotation may cause the position of the movable section (e.g., section 1664) to be adjusted. Torque wrenches or other tools may be used to rotate the end screws to ensure that appropriate amounts of tension are accomplished in the fibers.

At operation 2212, a primary tube may be moved to an appropriate position on each of the fibers. An example of this is illustrated in FIG. 16G. The primary tubes may be moved until they come in contact with a stop such as a bracket (e.g., bracket 1687).

At operation 2214, additional brackets may be attached to restrict movement of any primary tubes and any secondary tubes. An example of this is illustrated in FIG. 16H. A bracket (e.g., second bracket 1670B) may be attached via a screw to ensure that primary tubes are held in place. Before this bracket is attached, the primary tubes may be rotated so that any window therein is accessible for later stages so that epoxy may be easily dispensed into the window. Another bracket (e.g., third bracket 1670C) may be attached via a screw to ensure that the secondary tubes remain separated from the primary tubes until later stages.

At operation 2216, the system may be heated. Heating may be conducted using a heating coil assembly similar to heating coil assembly 1656 illustrated in FIG. 16I, by using another heating coil assembly, or by using another heating technique.

At operation 2218, a bracket may be removed to allow any secondary tubes to move towards corresponding primary tubes. For example, the third bracket 1670C of FIG. 16H may be removed to allow any secondary tubes to move towards primary tubes.

At operation 2220, epoxy may be injected into the primary tubes. Epoxy may be injected as indicated in the discussion of FIG. 19B, with the primary tube being oriented in an upright manner and with epoxy being dispensed at a level below the window in the primary tube.

At operation 2222, a secondary tube may be received within each primary tube. This may allow the epoxy to bond the secondary tubes and the primary tubes together. An example of this is illustrated in FIG. 16J. At operation 2224, further epoxy may be injected into the primary tubes if necessary. At operation 2226, further ultraviolet curing or thermal curing may be performed.

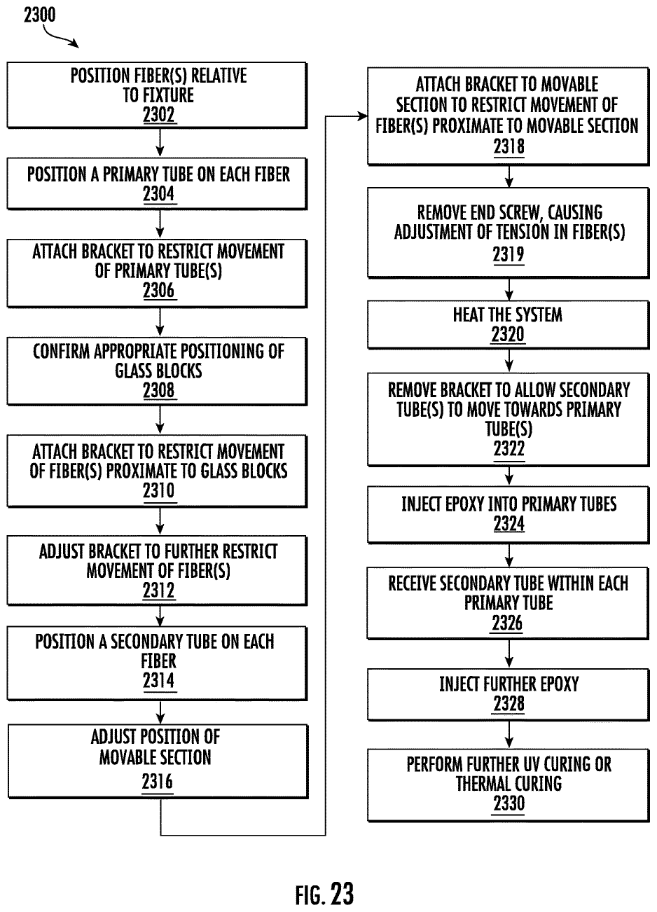

FIG. 23 illustrates another example method 2300 of forming a hermetic fiber feedthrough assembly. This method 2300 may generally correspond to the approach used in FIGS. 18A-18F.

At operation 2302, one or more fibers may be positioned relative to the fixture. Fibers may be positioned so that glass blocks attached on the fibers are positioned in sinks within the fixture. Additionally, fibers may be positioned so that they generally extend straight without excessive bending at any point along the length of the fibers. Fibers may be positioned so that they are received in grooves formed within the fixture. In some embodiments, fibers and glass blocks may be positioned as shown in FIG. 18A.

At operation 2304, a primary tube may be positioned on each fiber. An example of this is illustrated in FIG. 18A. These primary tubes are each hollow and define internal volumes. Primary tubes may be adjusted in position on the fibers so that the primary tubes rest proximate to grooves in the fixture. The fibers may generally be allowed to extend straight as the primary tubes are repositioned.

At operation 2306, a bracket may be attached to restrict movement of any primary tubes. An example of this is illustrated in FIG. 18B, and the bracket introduced at operation 2306 may correspond to the second bracket 1870B of FIG. 18B. A screw (e.g., second screw 1868B) may be used to secure the bracket, and a guide rod may be used to guide the bracket and to ensure that the bracket is positioned at the appropriate position.

At operation 2308, appropriate positioning of glass blocks may be evaluated and confirmed. Additionally, the appropriate positioning of the fibers that the glass blocks are attached to may be confirmed. Microscopes may be used to evaluate the positioning of the glass blocks and/or the fibers at operation 2306. However, appropriate positioning may be confirmed through a visual inspection without the use of a microscope in some embodiments, or appropriate positioning may be confirmed in other ways.

At operation 2310, a bracket may be attached to restrict movement of any fibers proximate to their respective glass blocks. An example of this is illustrated in FIG. 18C, and the bracket introduced at operation 2310 may correspond to the first bracket 1870A of FIG. 18C. A screw (e.g., first screw 1868A) may be used to secure the bracket, and a guide rod may be used to guide the bracket and to ensure that the bracket is positioned at the appropriate position. The fibers may be adjusted so that an appropriate tension level is present in them before the bracket is attached.

At operation 2312, an additional bracket may be attached to further restrict movement of any fibers. An example of this is illustrated in FIG. 18D, and the bracket introduced at operation 2312 may correspond to the third bracket 1870C of FIG. 18D. A screw (e.g., third screw 1868C) may be used to secure the bracket, and a guide rod may be used to guide the bracket and to ensure that the bracket is positioned at the appropriate position.

At operation 2314, a secondary tube may be positioned on each fiber. An example of this is illustrated in FIG. 18D, where secondary tubes 1816A, 1816B are introduced.

At operation 2316, the position of the movable section may be adjusted. An example of this is illustrated in FIG. 18E. An end screw (e.g., end screw 1872) may be rotated, and this rotation may cause the position of the movable section (e.g., section 1864) to be adjusted. Torque wrenches or other tools may be used to rotate the end screws in appropriate amounts. By doing so, appropriate amounts of tension may be accomplished in the fibers when the end screws are removed.

At operation 2318, a bracket may be attached to a movable section to restrict movement of any fibers proximate to the moveable section. An example of this is illustrated in FIG. 18F, and the bracket introduced at operation 2318 may correspond to the fourth bracket 1870D of FIG. 18F. The bracket may be attached to the movable section (e.g., section 1864 of FIG. 18F). A screw (e.g., fourth screw 1868D) may be used to secure the bracket, and a guide rod may be used to guide the bracket and to ensure that the bracket is positioned at the appropriate position.

At operation 2319, an end screw (e.g., end screw 1872) may be removed. As the end screw is removed, the end screw may cause the moveable section to move, thereby causing an adjustment in the tension within the fibers. In some embodiments, controlling a torque level at the end screw or the amount of rotation at the end screw during operation 2316 may effectively control the amount of increased tension in the fibers after operation 2319.

At operation 2320, the system may be heated. Heating may be conducted using a heating coil assembly similar to the heating coil assembly 1656 illustrated in FIG. 16I, by using another heating coil assembly, or by using another heating technique.

At operation 2322, a bracket may be removed to allow any secondary tubes to move towards a respective primary tube. For example, the third bracket 1870C of FIG. 18E may be removed to allow any secondary tubes to move towards primary tubes.

At operation 2324, epoxy may be injected into each primary tube. Epoxy may be injected as described in the discussion of FIG. 19B, with the primary tube being oriented in an upright manner and with epoxy being dispensed at a level below the window in the primary tube.

At operation 2326, a secondary tube may be received within each primary tube. This may allow the epoxy to bond the secondary tubes and the primary tubes together. At operation 2328, further epoxy may be injected into primary tubes if necessary. At operation 2330, further ultraviolet curing or thermal curing may be performed.

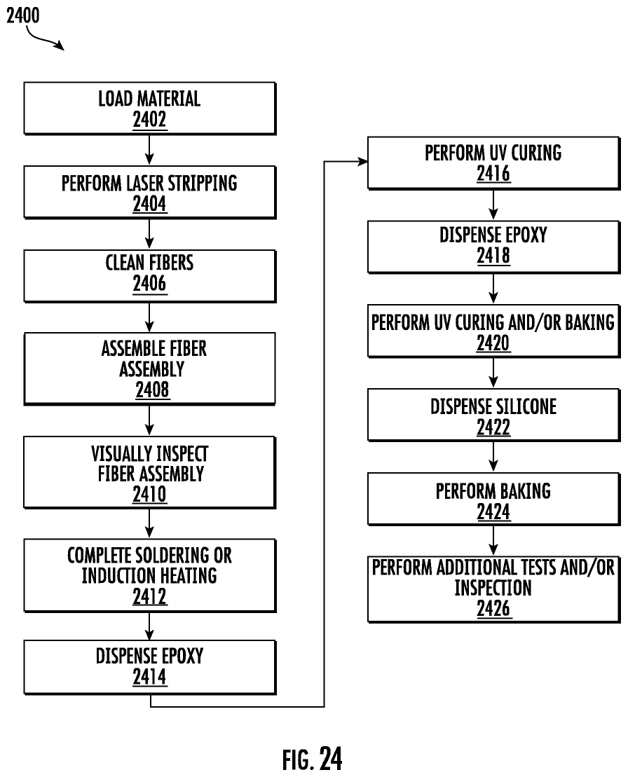

FIG. 24 illustrates another example method 2400 of forming a hermetic fiber feedthrough assembly. At operation 2402, material may be loaded or otherwise produced. This material may include fixtures, fibers, glass capillaries, glass preforms, primary tubes, secondary tubes, and other materials. Tubes may be cleaned, baked, cut, and/or inspected before being used.

At operation 2404, laser stripping may be performed. Laser stripping may be used to strip material from fibers with high precision. Even after laser stripping, the tension strength in fibers may still be maintained at high levels. Fibers may be cleaned at operation 2406.

At operation 2408, a fiber assembly such as a hermetic feedthrough assembly may be assembled. The fiber assembly may be assembled using methods similar to methods 2100, 2200, 2300 of FIGS. 21-23 and other methods described herein for forming fiber assemblies.

At operation 2410, the assembled hermetic feedthrough assembly may be inspected to evaluate for any defects. This inspection may entail a visual inspection from a person, but other tools may be utilized to perform the inspection. Additionally, or alternatively, automated, or semi-automated inspections may be performed. The inspections may ensure that assembled hermetic feedthrough assemblies are effective.

At operation 2412, soldering or induction heating may be completed. This may be performed using a heating coil assembly similar to the one illustrated in FIG. 12 or 16I. In some embodiments, soldering or induction heating may occur at a temperature between about 325 degrees Celsius and about 400 degrees Celsius, or heating may occur at a temperature between about 350 degrees Celsius and about 375 degrees Celsius. Additionally, in some embodiments, soldering or induction heating may occur for a time between about 50 seconds and about 160 seconds, or heating may occur for a time between about 60 seconds and about 150 seconds. However, the soldering or induction heating properties may be different in other embodiments, and the properties may rely on the characteristics of glass soldering materials. By performing soldering or induction heating, fibers may be kept straight even if fiber assemblies are not fixed by brackets before baking, and this heating may also help to reduce or prevent capillarity.

At operation 2414, epoxy may be dispensed. This may be performed after a fixture has been removed from a heating coil assembly. Epoxy may be dispensed into the primary tubes. While doing so, a fixture may be held in one hand while the epoxy is dispensed manually using another hand. However, in other embodiments, the epoxy may be dispensed in an automated manner. The secondary tubes may be shifted into the primary tubes after the epoxy is dispensed. Ultraviolet curing may be performed after the epoxy is dispensed at operation 2416. In some embodiments, further epoxy may be dispensed after ultraviolet curing may be performed at operation 2418, and then further ultraviolet curing and/or baking may be performed at operation 2420. Further cycles of epoxy dispensing, curing, or baking may be performed if appropriate.

At operation 2422, silicone may be dispensed on fiber assemblies. The silicone may provide a translucent coating on the fiber assemblies to protect against corrosion, to provide improved flame resistance, and/or to provide improved pin/solder joint coverage. However, the use of silicone may provide other benefits. While silicone is dispensed in the illustrated method 2400 of FIG. 24, another material may be dispensed in other embodiments. At operation 2424, the fiber assemblies may be baked or otherwise heated. At operation 2426, additional tests and/or inspection may be performed to ensure that the fiber assembly is effective. The testing may include a visual inspection, a leak test, a length inspection, or other testing.

The methods described herein are merely exemplary. Some or all of the operations for methods described herein may be combined together in some embodiments. Additional operations may be added for methods described herein, or certain operations may be omitted from certain methods described herein. Additionally, operations may be performed in different orders than they are presented in methods described herein, and certain operations may be performed simultaneously in some embodiments.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A system for formation of a fiber assembly, the system comprising:
a fixture comprising:
a first portion; and
a second portion;
a fiber; and
a first tube defining a first cavity therein, the first tube being configured to receive the fiber in the first cavity,
a vacuum fixture removably attachable to the fixture configured to supply vacuum suction to assist in maintaining positioning of the first tube, the fiber, and the fixture relative to each other,
wherein the first portion is configured to be fixed relative to the fiber,
wherein the second portion is configured to be fixed relative to the first tube move relative to the first portion to move the first tube relative to the fiber, and
wherein the second portion comprises a groove configured to receive the first tube.

2. The system of claim 1, wherein the second portion comprises a groove and the second portion is configured to receive the first tube at the groove.

3. The system of claim 2, wherein the groove is a V-groove.

4. The system of claim 2, wherein the groove is configured to reduce heat loss from the first tube during glass soldering.

5. The system of claim 1, further comprising:
epoxy,
wherein the epoxy is positioned at the first tube.

6. The system of claim 1, further comprising:
a second tube defining a second cavity therein, the second tube configured to receive the fiber in the second cavity.

7. The system of claim 6, further comprising:
epoxy,
wherein the epoxy is configured to assist in positioning the first tube relative to the second tube.

8. The system of claim 1, further comprising:
a first bracket configured to be attached to the first portion of the fixture to assist in fixing the fiber relative to the first portion of the fixture.

9. The system of claim 1, further comprising:
a second bracket configured to be attached to the second portion of the fixture to assist in fixing the first tube relative to the second portion of the fixture.

10. The system of claim 9, further comprising:
a pin positioned adjacent to the first tube,
wherein the second bracket is configured to receive the pin, and wherein the pin is configured to be urged against the first tube.

11. The system of claim 1, further comprising:
at least one positioning screw configured to be adjustable to change a position of the first portion relative to the second portion.

12. The system of claim 1, wherein the fixture, the first tube, and the fiber are configured to be thermally cured.

13. The system of claim 12, wherein the fixture, the fiber, and the first tube are configured to be heated by an induction heating coil.

14. The system of claim 13, wherein the fixture, the first tube, and the fiber are configured to undergo ultraviolet curing.

15. An assembly for formation of a fiber assembly, the assembly comprising:
a fixture comprising:
a first portion; and
a second portion; and
a vacuum fixture configured to supply one or more suction forces,
wherein the first portion is configured to be fixed relative to a fiber, wherein the second portion is configured to be fixed relative to a first tube defining a first cavity configured to receive the fiber therein, wherein the second portion is configured to move relative to the first portion to move the first tube relative to the fiber, and wherein the vacuum fixture is configured to assist in maintaining positioning of the first tube, the fiber, and the fixture relative to each other by supplying vacuum suction.

16. A fixture for formation of a fiber assembly, the fixture comprising:
a first portion; and
a second portion; and
wherein the first portion is configured to be fixed relative to a fiber, wherein the second portion is configured to be fixed relative to a first tube defining a first cavity configured to receive the fiber therein, and wherein the second portion is configured to move relative to the first portion to move the first tube relative to the fiber.

17. The fixture of claim 16, wherein the second portion comprises a V-groove and the second portion is configured to receive the first tube at the V-groove.

18. A method for using a fixture for forming of a fiber assembly, the method comprising:
providing a first tube defining a first cavity therein, the first tube configured to receive a fiber in the first cavity;
positioning the first tube so that a fiber is received in the first cavity;
providing a fixture comprising a first portion and a second portion, the second portion being configured to move relative to the first portion;
fixing the fiber relative to the first portion of the fixture; and
fixing the first tube relative to the second portion of the fixture.

19. The method of claim 18, further comprising:
moving the first portion of the fixture relative to the second portion of the fixture to move the first tube relative to the fiber.

20. The method of claim 18, wherein fixing the fiber relative to the first portion of the fixture is accomplished using a first bracket.
